(19) United States
(12) Patent Application Publication
(10) Pub. No.: US 2026/0153895 A1
(43) Pub. Date: Jun. 4, 2026

(54) SAFETY DEVICE FOR COOKING APPLIANCE AND COOKING APPLIANCE INCLUDING SAME

(71) Applicant: LG ELECTRONICS INC., Seoul (KR)

(72) Inventors: SangHyeok CHO, Seoul (KR); Seok Jin BANG, Seoul (KR); Dong Hyun KIM, Seoul (KR); Jihyun KIM, Seoul (KR); Yik Soo NA, Seoul (KR)

(73) Assignee: LG ELECTRONICS INC., Seoul (KR)

(21) Appl. No.: 19/404,434

(22) Filed: Dec. 1, 2025

(30) Foreign Application Priority Data
Dec. 2, 2024 (KR) 10-2024-0176632
Dec. 2, 2024 (KR) 10-2024-0176633

(51) Int. Cl. G05G 1/08; F24C 3/12

(52) U.S. Cl. CPC G05G 1/082; F24C 3/124

(57) ABSTRACT

Proposed are a safety device (200) for a cooking appliance and a cooking appliance including the safety device (200). The safety device (200) includes a first body portion (210), and a second body portion (230) having a first end portion connected to the first body portion (210) and a second end portion spaced apart from the first end portion along a longitudinal direction thereof. An interference region (A) having an axial thickness greater than that of the first body portion (210) is defined in the second body portion (230). The first body portion (210) has a mounting hole (215) through which a drive shaft (71) passes and which serves as a rotational center of the safety device (200). The interference region (A) prevents the knob assembly (100) from being pressed unintentionally in the locked position.

### CROSS REFERENCE TO RELATED APPLICATION

The present application claims priority to Korean Patent Application Nos. 10-2024-0176632 and 10-2024-0176633, filed Dec. 2, 2024, the entire contents of which are incorporated herein for all purposes by this reference.

### BACKGROUND OF THE INVENTION

### Field of the Invention

The present disclosure relates to a safety device for a cooking appliance and a cooking appliance including the safety device.

### Description of the Related Art

A cooking appliance is used to cook food ingredients to prepare meals. The cooking appliance may also be used to heat food to a temperature suitable for consumption. Such a cooking appliance may be classified in various ways depending on the type of heat source, the kind of fuel used, etc. For example, the cooking appliance may be classified as an open-type cooking appliance or a closed-type cooking appliance according to the form of a space in which food ingredients are placed. The closed-type cooking appliance includes ovens and microwave ovens, whereas the open-type cooking appliance includes cooktops and griddles.

The closed-type cooking appliance may shield a space in which food ingredients are placed by means of a door, and may cook the food ingredients by heating the shielded space. The open-type cooking appliance may have an exposed space in which food ingredients or a container holding the food ingredients are placed, and may cook the food ingredients by heating the food ingredients or the container. Recently, a hybrid cooking appliance in which the closed-type cooking appliance and the open-type cooking appliance are installed together has also been used. The hybrid cooking appliance may combine various heat sources to cook various types of food ingredients and may also cook multiple meals simultaneously.

The cooking appliance may be provided with a knob for operation. The knob may be used to turn the cooking appliance on and off or to set a cooking mode. In addition, the knob may be used to adjust a heating temperature.

In the cooking appliance, taking a gas range as an example, the knob may be operated in a push-and-turn manner to operate the cooking appliance. The knob of the push-and-turn type may be configured such that the cooking appliance can be operated only when a user pushes and rotates the knob. In this case, the user may adjust a heating temperature or select a cooking mode by adjusting the amount of rotation of the knob about a drive shaft while pressing the knob. Since both the pushing and turning operations are required to operate the cooking appliance, the safety of the cooking appliance can be enhanced.

However, even the knob of the push-and-turn type is exposed outward, and thus a user may unintentionally push and rotate the knob. For example, a user's body may contact the knob without the user realizing it, thereby pushing and turning the knob at the same time. In addition, a case may also occur in which a child manipulates the knob to operate the cooking appliance. When the knob is operated inadvertently in this manner, fire or burn accidents may occur. Accordingly, it is necessary to further enhance the safety of the cooking appliance.

### SUMMARY OF THE INVENTION

Accordingly, the present disclosure has been made to solve the above problems occurring in the related art, and an objective of the present disclosure is to prevent a knob from being unintentionally pressed in a situation unintended by a user.

Another objective of the present disclosure is to switch the safety device to a locked state after rotating the safety device by a predetermined angle, thereby preventing the safety device from being switched to an unlocked state by gravity.

Another objective of the present disclosure is to allow the locked state (press-preventing state) and the unlocked state (press-allowable state) of the knob to be easily switched when the safety device slides while mounted on the cooking appliance.

Another objective of the present disclosure is to enable a user to easily and stably grip the safety device when operating the safety device.

Another objective of the present disclosure is to allow the safety device to easily rotate about the knob without significant friction with the knob or the cooking appliance.

Another objective of the present disclosure is to allow the safety device to block pressing of the knob in a situation unintended by a user and to be applied to knobs of various sizes and spacings.

Another objective of the present disclosure is to ensure that the safety device does not interfere with the axial movement of the knob when the safety device is located at an unlocked position.

Another objective of the present disclosure is to allow the locked state and the unlocked state to be easily switched from each other while the safety device slides in a state of being mounted to the cooking appliance.

Another objective of the present disclosure is to allow the safety device to rotate about the knob without interfering with adjacent knobs.

In order to achieve the objectives of the present disclosure, according to the features of the present disclosure, there is provided a safety device which includes a first body portion, and a second body portion having a first end portion connected to the first body portion and a second end portion spaced apart from the first end portion along a longitudinal direction thereof. The second body portion may define an interference region having an axial thickness greater than that of the first body portion. The first body portion may have a mounting hole through which a drive shaft passes and which serves as a rotational center of the safety device. The interference region may prevent a knob assembly from being unintentionally pressed in a locked position. Accordingly, even when an external force is applied to press a knob due to contact of a user's body with the knob without the user's awareness, the safety device may support the knob in an axial direction to prevent the knob from being pressed.

The mounting hole may be formed at a position outside the interference region.

The interference region may have different axial thicknesses along the longitudinal direction.

An inner diameter of the mounting hole may be larger than an outer diameter of the drive shaft or an outer diameter of a base portion through which the drive shaft passes.

A partition portion may be defined between the first body portion and the first end portion of the second body portion connected to the first body portion. With respect to the partition portion, an axial thickness of the second body portion may be greater than an axial thickness of the first body portion. The mounting hole may be formed at a position spaced apart from the partition portion toward a second end portion of the first body portion.

The mounting hole may form a closed curve within the first body portion.

The interference region may be defined between the partition portion and the second end portion of the second body portion.

The first body portion may have a uniform axial thickness throughout an entire region thereof. The first body portion may continuously surround an edge of the mounting hole along a circumferential direction of the mounting hole.

The first body portion and the second body portion may be divided with respect to the partition portion. With respect to the partition portion, the first body portion and the second body portion may have thicknesses different from each other.

The first end portion of the first body portion and the first end portion of the second body portion may each be connected to the partition portion. A distance between the second end portion of the first body portion, which is spaced farthest from the partition portion, and the partition portion may be greater than a distance between the second end portion of the second body portion, which is spaced farthest from the partition portion, and the partition portion.

The first end portion of the first body portion and the first end portion of the second body portion may each be connected to the partition portion. A distance between the second end portion of the first body portion, which is spaced farthest from the partition portion, and a center of the mounting hole may be greater than a distance between the partition portion and the center of the mounting hole.

The second body portion may include a through hole having a closed curve independent of the mounting hole.

A diameter of the mounting hole may be larger than a diameter of the through hole.

The distance between the partition portion and the center of the mounting hole may be greater than a distance between the partition portion and a center of the through hole.

The interference region may be defined between the edge of the mounting hole and an edge of the through hole.

The center of the mounting hole and the center of the through hole may be aligned along a longitudinal direction of the first body portion and the second body portion.

The second body portion may be provided with a handle portion protruding in a direction opposite to a direction toward the first body portion.

With respect to a width in a direction orthogonal to the longitudinal direction of the first body portion and the second body portion, the first body portion and the second body portion may respectively have different widths.

With respect to a reference line extending in the longitudinal direction of the first body portion and the second body portion, the second body portion may have a symmetrical structure in the axial direction.

According to the present disclosure, the safety device may include the base portion disposed on an operation panel, a drive shaft protruding forward through the base portion, and the knob assembly coupled to the drive shaft to move rectilinearly in the axial direction of the drive shaft. In this case, the safety device may be disposed between the operation panel and the knob assembly.

The safety device may have the locked position in which the interference region is disposed between the knob assembly and the operation panel along the axial direction, and an unlocked position in which the interference region is moved in a direction different from the axial direction such that the interference region is positioned outside the space between the knob assembly and the operation panel.

The safety device may have a first position in which the second end portion of the second body portion faces downward, a second position in which the second end portion of the second body portion faces upward by rotating about the mounting hole, and a third position in which, in the second position, the safety device moves downward so that the interference region is disposed between the knob assembly and the operation panel.

When the center of the mounting hole and the center of the base portion are concentrically aligned, an entire inner circumferential surface of the mounting hole may be spaced apart from an entire outer circumferential surface of the base portion.

The safety device may have the locked position in which the interference region limits the axial movement of the knob assembly, and the unlocked position in which the safety device moves in a direction different from the axial direction such that the axial movement of the knob assembly is allowed.

A difference between the inner diameter of the mounting hole and the outer diameter of the base portion may be greater than or equal to a distance between the locked position and the unlocked position.

The operation panel may be provided with a heating drive part to which the drive shaft is connected. The knob assembly may move the drive shaft by a reference distance in the axial direction to drive the heating drive part. The axial distance between the surface of the first body portion and the knob assembly may be greater than or equal to the reference distance.

The safety device may include the first body portion, and the second body portion having the first end portion connected to the first body portion and the second end portion spaced apart from the first end portion in the longitudinal direction. The first body portion may include the mounting hole through which the drive shaft of the cooking appliance passes and which serves as the rotational center of the safety device. In this case, stepped portions having thicknesses changing in the axial direction may be formed on a boundary portion between the first body portion and the second body portion. Accordingly, even when an external force is applied to press the knob by a user's body coming into contact with the knob in a state in which the user does not recognize it, the safety device may support the knob in the axial direction to prevent the pressing of the knob.

The stepped portions may be formed to protrude in the axial direction from the boundary portion.

On the boundary portion, the plurality of stepped portions may be provided to be spaced apart from each other. The plurality of stepped portions may be arranged along an arcuate shape.

Virtual extension lines that extend in normal directions from surfaces of the plurality of stepped portions, respectively, may intersect each other within a region of the mounting hole.

With respect to a longitudinal centerline connecting a center of the first body portion and a center of the second body portion, the plurality of stepped portions may have a left-right symmetrical structure.

The stepped portions may be inclined surfaces or curved surfaces.

The stepped portions may be formed along a path of the arcuate shape on the boundary portion.

A pair of the stepped portions may be provided on opposite side portions of the through hole, respectively.

A virtual centerline passing through both the center of the mounting hole and the center of the through hole may be formed. The virtual extension lines extending in the normal direction from surfaces of the stepped portions may intersect the virtual centerline.

The center of the mounting hole and the center of the through hole may be aligned along the longitudinal direction of the first body portion and the second body portion.

The stepped portions may be disposed between the mounting hole and the through hole. The mounting hole may be formed at a position spaced apart from the stepped portions.

An area of the mounting hole may be larger than an area of the through hole.

With respect to the width in a direction orthogonal to the longitudinal direction of the first body portion and the second body portion, the first body portion and the second body portion may have widths different from each other.

A recessed portion may be formed between a side surface of the first body portion and a side surface of the second body portion.

The first end portion of the second body portion may be connected to the stepped portions. The second end portion of the second body portion may have a curved shape.

The second body portion may include the first end portion connected to the stepped portions and the second end portion spaced farthest from the stepped portions. The second body portion may have a thickness that gradually increases from the first end portion toward the second end portion.

The second body portion may include a plurality of regions having different axial thicknesses along the radial direction of the mounting hole.

The inner diameter of the mounting hole may be greater than the outer diameter of the drive shaft or the outer diameter of the base portion through which the drive shaft passes.

A shortest distance between the edge of the mounting hole and each of the stepped portions may be greater than a shortest distance between the stepped portion and the second end portion of the second body portion.

The interference region having an axial thickness greater than that of the first body portion may be defined in the second body portion.

The safety device of the present disclosure may include the drive shaft that passes through the operation panel and protrudes forward, and the knob assembly coupled to the drive shaft and configured to rectilinearly move in the axial direction of the drive shaft. In this case, the second body portion may be disposed between the knob assembly and the operation panel, and the axial movement of the knob assembly may be limited.

In an unlocked state in which the second body portion protrudes radially outward to a maximum from the knob assembly, the stepped portions may be disposed radially outside of the outer peripheral surface of the knob assembly.

In the unlocked state in which the second body portion protrudes radially outward to a maximum from the knob assembly, a radial distance between the center of the drive shaft and the radial end of the knob assembly may be shorter than a radial distance between the center of the drive shaft and the stepped portion.

As described above, the safety device for a cooking appliance and the cooking appliance including the safety device according to the present disclosure may have the following effects.

According to the present disclosure, the safety device for a cooking appliance may prevent the knob assembly from being unintentionally pressed in the locked position. That is, according to the present disclosure, even when an external force is applied to press a knob due to contact of a user's body with the knob without the user's awareness, the safety device may support the knob in the axial direction to prevent the knob from being pressed. Accordingly, the safety device of the present disclosure may block the pressing of the knob in a situation unintended by the user so that the cooking part of the cooking appliance is not operated, thereby improving the safety of the cooking appliance.

Furthermore, the safety device of the present disclosure may rotate about the knob assembly and may be positioned at the upper end (12 o'clock position) of the knob assembly. Since the safety device positioned at the upper end of the knob assembly is supported by the knob assembly, so that there is no risk of downward movement of the safety device due to gravity. Accordingly, the safety device of the present disclosure may prevent a locked state from being unintentionally released by gravity, thereby further enhancing the safety of the cooking appliance.

In addition, according to the present disclosure, the safety device for a cooking appliance may include the first body portion in which the mounting hole is formed, and the second body portion in which the interference region is defined. In this case, the second body portion, which is relatively heavy due to its thickness, may be directed downward under gravity with the mounting hole serving as the rotational center. In this state, the safety device for a cooking appliance may have the unlocked position. Accordingly, the safety device for a cooking appliance of the present disclosure may basically have the unlocked position, and a user may rotate the safety device for a cooking appliance to the locked position only when necessary, thereby providing improved user convenience.

Additionally, the safety device of the present disclosure may slide in a state of being mounted to the cooking appliance. The safety device may be easily switched between the locked state (a press-preventing state) of the knob and the unlocked state (a press-allowable state) of the knob while sliding on the cooking appliance. Through this, the safety device may enhance the operational convenience of a user.

Furthermore, the safety device of the present disclosure may include the first body portion serving as the rotational center and the second body portion configured to prevent the pressing of the knob assembly. In this case, the through hole may be formed in the second body portion, allowing a user to easily grip the safety device through the through hole. Accordingly, the user may easily rotate or rectilinearly move the safety device through the through hole, thereby improving the operability of the safety device.

In addition, when the interference region is compressed between the knob assembly and the cooking appliance, the compressed portion may be elastically deformed in a direction in which the through hole is filled. Accordingly, compression of the interference region may be more easily achieved, and a force required to switch the safety device to the locked state may be reduced, thereby improving user convenience.

Meanwhile, according to the present disclosure, the mounting hole serving as the rotation center of the safety device may be formed at a position outside the interference region that interferes with the knob assembly. In this case, a through portion may not be formed in the interference region that brings the knob assembly into the locked state, and a wide contact area of the interference region with the knob assembly may be secured in the interference region. Accordingly, the state in which the safety device interferes between the knob assembly and the cooking appliance may be stably maintained, thereby improving the safety of the cooking appliance.

In addition, according to the present disclosure, since the mounting hole is positioned outside the interference region, the mounting hole may exclusively serve the mounting and rotation functions of the safety device, independently of bringing the knob assembly into the locked state. Accordingly, the mounting hole may be formed with a sufficiently large diameter to facilitate the rotation of the safety device without significant friction.

Furthermore, according to the present disclosure, since the mounting hole is positioned outside the interference region that brings the knob assembly into the locked state, the mounting hole may be formed to have various diameters. Accordingly, the safety device may have increased design freedom and may be applied to knobs of various sizes and spacings, thereby improving compatibility.

Additionally, according to the present disclosure, the stepped portion of the safety device may be formed along a substantially arcuate shape to correspond to the outer end of the knob assembly. In this way, interference between the safety device and the knob assembly in the unlocked state may be minimized without increasing the size of the safety device.

Particularly, in this way, by making the size of the safety device small, the radially protruding length of the safety device may be smaller than that of the knob assembly. The safety device with a shorter protruding length may rotate without interfering with adjacent knobs. Accordingly, the operability of the safety device may be improved.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view showing a cooking appliance to which a knob assembly is applied according to a first embodiment;

FIG. 2 is a perspective view showing a state in which safety devices for a cooking appliance according to the present disclosure are mounted on an operation panel of the cooking appliance in different directions;

FIG. 3 is an exploded perspective view showing components constituting a cooking appliance to which the safety device for a cooking appliance is applied according to the first embodiment of the present disclosure;

FIG. 4 is an exploded perspective view showing the components constituting the cooking appliance, to which the safety device for a cooking appliance according to the first embodiment of the present disclosure is applied, from a different angle than that of FIG. 3;

FIG. 5 is a cross-sectional view taken along line V-V′ of FIG. 2;

FIG. 6 is a cross-sectional view taken along line VI-VI′ of FIG. 2;

FIG. 7 is a cross-sectional view showing a state in which the safety device for a cooking appliance according to the first embodiment of the present disclosure is moved to a locking position in FIG. 6;

FIG. 8 is an enlarged cross-sectional view showing interference in an axial direction between a second body portion and the knob assembly, in a state where the safety device for a cooking appliance according to the first embodiment of the present disclosure is moved to the locking position;

FIG. 9 is a perspective view showing the configuration of the safety device for a cooking appliance according to the first embodiment of the present disclosure;

FIG. 10 is a perspective view showing the configuration of the safety device for a cooking appliance according to the first embodiment of the present disclosure from a different angle than that of FIG. 9;

FIG. 11 is a front view showing the configuration of the safety device for a cooking appliance according to the first embodiment of the present disclosure;

FIG. 12 is a side cross-sectional view showing the configuration of the safety device for a cooking appliance according to the first embodiment of the present disclosure;

FIGS. 13 to 16 are views sequentially illustrating operational states in which the safety device for a cooking appliance moves from an unlocked position to a locked position according to the first embodiment of the present disclosure;

FIGS. 17 and 18 are perspective views showing the configuration of a safety device for a cooking appliance from different angles according to a second embodiment of the present disclosure;

FIG. 19 is a perspective view showing the configuration of a safety device for a cooking appliance according to a third embodiment of the present disclosure;

FIGS. 20 and 21 are a perspective view and a cross-sectional view, respectively, showing the configuration of a safety device for a cooking appliance according to a fourth embodiment of the present disclosure;

FIG. 22 is a perspective view showing the configuration of a safety device for a cooking appliance according to a fifth embodiment of the present disclosure;

FIG. 23 is a perspective view showing the configuration of a safety device for a cooking appliance according to a sixth embodiment of the present disclosure;

FIG. 24 is a perspective view showing the configuration of a safety device for a cooking appliance according to a seventh embodiment of the present disclosure;

FIG. 25 is a front view showing the configuration of a safety device for a cooking appliance according to an eighth embodiment of the present disclosure;

FIG. 26 is a front view showing the configuration of a safety device for a cooking appliance according to a ninth embodiment of the present disclosure;

FIG. 27 is a perspective view showing a state in which safety devices for a cooking appliance according to a tenth embodiment of the present disclosure are mounted on the operation panel of a cooking appliance in different directions;

FIG. 28 is an exploded perspective view showing components constituting a cooking appliance, in which the safety device for a cooking appliance according to the tenth embodiment of the present disclosure is applied;

FIG. 29 is an exploded perspective view showing components of the cooking appliance, to which the safety device for a cooking appliance according to the tenth embodiment of the present disclosure is applied, from a different angle than that of FIG. 28;

FIG. 30 is a cross-sectional view taken along line V-V′ of FIG. 27;

FIG. 31 is a cross-sectional view taken along line VI-VI′ of FIG. 27;

FIG. 32 is a cross-sectional view showing a state in which the safety device for a cooking appliance according to the tenth embodiment of the present disclosure in FIG. 31 is moved to the locked position;

FIG. 33 is an enlarged cross-sectional view showing interference in the axial direction between the second body portion and the knob assembly in a state where the safety device for a cooking appliance according to the tenth embodiment of the present disclosure is moved to the locked position;

FIG. 34 is a perspective view showing the configuration of the safety device for a cooking appliance according to the tenth embodiment of the present disclosure;

FIG. 35 is an enlarged perspective view showing the structure of the stepped portion of the safety device for a cooking appliance according to the present disclosure;

FIG. 36 is a perspective view showing the configuration of the safety device for a cooking appliance according to the tenth embodiment of the present disclosure from a different angle than that of FIG. 34;

FIG. 37 is a front view showing the configuration of the safety device for a cooking appliance according to the tenth embodiment of the present disclosure;

FIG. 38 is a side cross-sectional view showing the configuration of the safety device for a cooking appliance according to the tenth embodiment of the present disclosure;

FIGS. 39 to 42 are views sequentially illustrating operational states in which the safety device for a cooking appliance according to the tenth embodiment of the present disclosure is moved from the unlocked position to the locked position;

FIG. 43 is a perspective view showing the configuration of a safety device for a cooking appliance according to an eleventh embodiment of the present disclosure;

FIG. 44 is a perspective view showing the configuration of a safety device for a cooking appliance according to a twelfth embodiment of the present disclosure; and

FIG. 45 is a front view showing the configuration of a safety device for a cooking appliance according to a thirteenth embodiment of the present disclosure.

### DETAILED DESCRIPTION OF THE INVENTION

Hereinafter, some embodiments of the present disclosure will be described in detail with reference to exemplary drawings. In assigning reference numerals to components of each drawing, it should be noted that the same reference numerals are assigned to the same components as much as possible, even if they are shown in different drawings. Furthermore, in describing the embodiments of the present disclosure, detailed descriptions of well-known configurations or functions will be omitted when it is determined that such descriptions may obscure the understanding of the embodiments of the present disclosure.

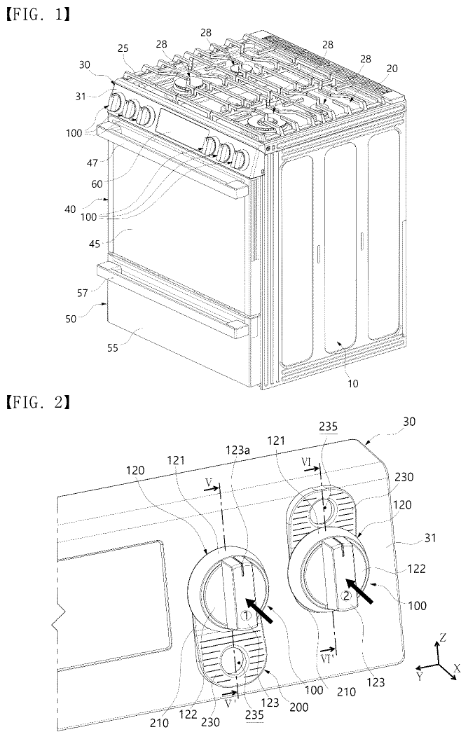

The present disclosure relates to knob assemblies 100 and a cooking appliance including the same, wherein a cooktop portion 20 including a plurality of heating devices 28 may be provided on an upper portion of the cooking appliance. Each of the heating devices 28 may be a gas heating device 28 using gas as energy, an electric cooktop, or an induction cooktop. In FIG. 1, the gas heating device 28 among the heating devices 28 included in the cooktop portion 20 is illustrated as an example. As shown in FIG. 1, the heating device 28 may be disposed to be exposed on the upper portion of the cooking appliance. In another example, the heating device 28 may be disposed inside the cooking appliance, or may be disposed both inside and outside the cooking appliance.

Each of the knob assemblies 100 may be used to operate the heating device 28. A user may turn the heating device 28 on or off by operating the knob assembly 100. A user may also adjust the amount of heat provided by the heating device 28 through the operation of the knob assembly 100. Alternatively, a user may operate the knob assembly 100 to operate an oven portion 40 and 50, or to select a cooking mode of the cooking appliance.

A user may control the heating device 28 by pressing and then rotating the knob assembly 100. In this case, as shown in FIG. 2, in order to prevent the knob assembly 100 from being unintentionally operated due to the mistake of a user or interference thereof with surrounding objects, the present disclosure may be provided with a safety device for a cooking appliance (hereinafter referred to as “the safety device 200”). Hereinafter, the cooking appliance will be described with an emphasis on the safety device 200 and a malfunction prevention structure.

Looking at the structure of the cooking appliance, the exterior of the cooking appliance may be constituted by an outer body 10. The outer body 10 may constitute the framework of the cooking appliance, except for doors disposed at a front side thereof. Inside the outer body 10, a separate inner housing (not shown) may be disposed.

One or more heating devices 28 for heating food to be cooked or a container containing the food may be disposed on the cooktop portion 20. In the present embodiment, a total of four heating devices 28 are disposed on the cooktop portion 20.

A grate 25 may be provided on the cooktop portion 20. The grate 25 may be a frame on which a cooking container is placed above the heating device 28. The grate 25 may be detachably seated on the cooktop portion 20. The grate 25 may be positioned on the upper portion of the heating device 28.

An operation panel 30 may be disposed on the upper portion of the oven portion 40 and 50 and at the front side of the cooktop portion 20. The operation panel 30 may include the knob assemblies 100 for operating the oven portion 40 and 50 and the cooktop portion 20. Each of the plurality of knob assemblies 100 may operate a separate heating device 28 or a separate oven device. The operation panel 30 may be regarded as an operating device or may be referred to as a front panel. The operation panel 30 may be disposed not at the front of the cooktop portion 20, but at various positions, such as the lower portion, side surface, or upper surface of the cooking appliance.

The operation panel 30 may be provided with a display part 60. The display part 60 may display information regarding the cooking appliance. The display part 60 may be configured as a touch panel and may be used by a user to operate the cooking appliance. That is, the display part 60 may also serve as a type of operating part 143. In another example, the display part 60 may be omitted.

Referring to the oven portion 40 and 50, the oven portion 40 and 50 may include a plurality of oven devices. In the present embodiment, the oven portion 40 and 50 may include a first oven device 40 and a second oven device 50. The first oven device 40 and the second oven device 50 may be arranged at different heights. Separate cooking chambers, which are partitioned from each other, may be formed in the first oven device 40 and the second oven device 50, respectively.

A first door 45 of the first oven device 40 may operate in a pull-down manner, in which an upper end thereof rotates up and down about a lower end thereof. In another example, the first door 45 may operate in a side-swing manner in which the first door 45 opens laterally. Reference numeral 47 denotes a handle for opening and closing the first door 45.

A second door 55 of the second oven device 50 may operate in a manner sliding in a front-rear direction. In another example, similar to the first door 45, the second door 55 may also operate in a pull-down manner, in which an upper end thereof rotates up and down about a lower end thereof. Reference numeral 57 denotes a handle for opening and closing the second door 55.

Next, the knob assembly 100 will be described. As shown in FIGS. 1 and 2, in the present embodiment, six knob assemblies 100 may be disposed on the operation panel 30. This is merely an example, and one to five knob assemblies 100 or seven or more knob assemblies 100 may be provided on the operation panel 30. The knob assembly 100 may include a substantially circular body and a portion protruding from the circular body to facilitate gripping. In another example, the knob assembly 100 may be disposed directly on the upper surface or side surface of the cooking appliance, instead of on the operation panel 30. In yet another example, the knob assembly 100 may be disposed at a lower front portion of the cooking appliance.

As shown in FIG. 2, in the present embodiment, the safety device 200 may be disposed between the knob assembly 100 and the operation panel 30. The safety device 200 may prevent the knob assembly 100 from being pressed in an axial direction thereof. When the safety device 200 limits the axial movement of the knob assembly 100, the operation of a heating drive part through the knob assembly 100 may also be impossible. For the operation of the heating drive part, the knob assembly 100 may be required to be first pressed and then rotated, but the pressing of the knob assembly 100, which is the first step, may be prevented. Accordingly, the safety device 200 may prevent the unintended operation of the cooking appliance.

In this case, the safety device 200 may create a locked state, which prevents the knob assembly 100 from being pressed, and an unlocked state, which allows the knob assembly 100 to be pressed, by changing its position between the knob assembly 100 and the operation panel 30. When the safety device 200 is disposed at a locked position, the locked state thereof may be implemented, and when the safety device 200 is disposed at an unlocked position, the unlocked state thereof may be implemented. This structure will be described in detail below.

For reference, as used herein, the term “axial direction” refers to the longitudinal direction of a drive shaft 71 (see FIG. 3), which corresponds to an X-axis direction in FIGS. 2 to 4. As used herein, the term “rotational direction” refers to the direction in which the knob assembly 100 rotates about the drive shaft 71. Furthermore, as used herein, the term “radial direction” refers to the radial direction of the drive shaft 71, which corresponds to the radial direction of the rotational path of the knob assembly 100 and also to the radial direction of a mounting hole 215 to be described below. As will be described below, the safety device 200 may rotate about the X-axis direction, which is the axial direction. The safety device 200 may also move rectilinearly in the Y-axis and Z-axis directions, which are orthogonal to the axial direction.

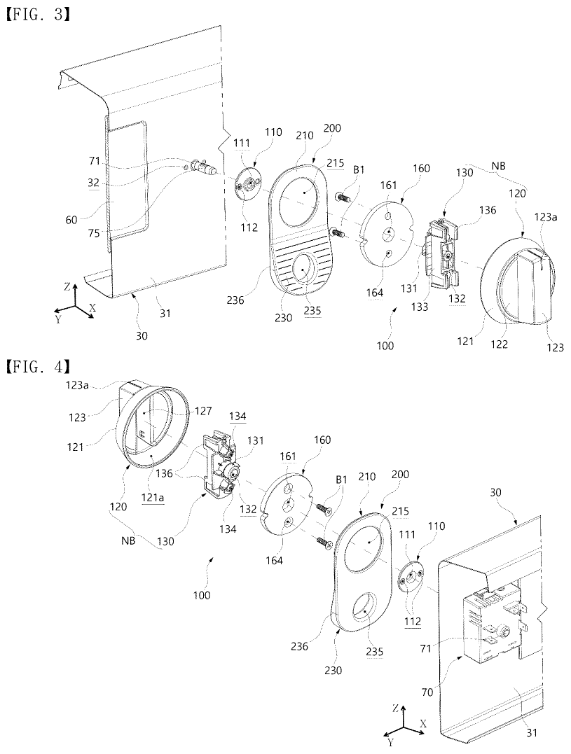

Referring to the detailed structure of the knob assembly 100, FIGS. 3 and 4 illustrate the components of the knob assembly 100 in an exploded view. For convenience of description, the drive shaft 71 will be described first. The drive shaft 71 may be coupled to the knob assembly 100. The drive shaft 71 may serve as the rotational center of the knob assembly 100. The drive shaft 71 may rotate together with the knob assembly 100 when the knob assembly 100 is rotated. When the knob assembly 100 moves in the axial direction, the drive shaft 71 may also move rectilinearly together with the knob assembly 100.

The drive shaft 71 may be provided in the heating drive part 70 (see FIG. 4). The heating drive part 70 may serve to supply energy to the heating device 28. For example, the heating drive part 70 may be configured to control the heating device 28 while being driven by the drive shaft 71. Accordingly, the drive shaft 71 may also be regarded as a valve shaft.

Here, energy may be gas or electricity. When energy is electricity, the heating drive part 70 may be referred to as a regulator, and when energy is gas, the heating drive part 70 may be referred to as a valve assembly. The drive shaft 71 may be a component constituting the knob assembly 100. In another example, the drive shaft 71 may be regarded as a portion of the heating drive part 70. Reference numeral 32 denotes plate through-holes through which fasteners (not shown) for fixing the base portion 110 pass.

More specifically, the drive shaft 71 may be coupled to the heating drive part 70 so as to be pushable and rotatable. In this case, the heating drive part 70 may prevent the drive shaft 71 from rotating when the drive shaft 71 is not pushed. As the drive shaft 71 is pushed and rotated with respect to the heating drive part 70, the heating drive part 70 may supply energy to the heating device 28.

The drive shaft 71 may be provided with a coupling member 75. The coupling member 75 may surround the outer circumferential surface of the drive shaft 71. The coupling member 75 may be made of an elastic material, such as a leaf spring. The coupling member 75 may be disposed between the drive shaft 71 and a shaft coupling portion 131 to be described later, and may provide an elastic force between the drive shaft 71 and the shaft coupling portion 131. Accordingly, the coupling member 75 may prevent the drive shaft 71 from being easily disengaged from the shaft coupling portion 131.

The drive shaft 71 may be operated through the knob assembly 100. More specifically, the drive shaft 71 may be coupled to the knob body NB and may rotate together with the knob body NB. The drive shaft 71 may also move rectilinearly in the axial direction together with the knob body NB. Accordingly, when a user operates the knob assembly 100, the heating drive part 70 may be driven via the drive shaft 71, thereby operating the heating device 28.

Referring to the structure of the knob assembly 100, the knob assembly 100 may be provided with a base portion 110. The base portion 110 may be disposed on a front plate 31 of the operation panel 30. A base hole 111 through which the drive shaft 71 passes may be formed in the base portion 110, and may support the rotation of the drive shaft 71. That is, the base portion 110 may allow the drive shaft 71 to rotate stably and move rectilinearly in the axial direction.

In another example, the base hole 111 may be omitted in the base portion 110. In this case, the drive shaft 71 may pass directly through the front plate 31 without passing through the base portion 110.

The base portion 110 may have a substantially disc-shaped structure. Base fixing holes 112 may be formed outside the base hole 111 with respect to the base hole 111 formed at the center of the base portion 110. The base fixing holes 112 are portions through which the fasteners (not shown) pass, and the fasteners may assemble the base portion 110 with the front plate 31.

In another example, the base portion 110 may be omitted. In yet another example, the base portion 110 may be integrally formed with the operation panel 30. That is, the base portion 110 may be regarded as a portion of the operation panel 30. In still another example, the base portion 110 may have various polygonal shapes instead of a disc shape.

The framework of the knob assembly 100 may be constituted by the knob body NB. The knob body NB may surround the drive shaft 71 and the base portion 110. The knob body NB may be a portion gripped by a user. In the present embodiment, the knob body NB may include a first knob body 120 and a second knob body 130. The first knob body 120 may be exposed to the outside. The second knob body 130 may be disposed inside the first knob body 120.

In the present embodiment, the first knob body 120 may be exposed to the outside and may serve as a portion operated by a user to manipulate the knob assembly 100. The second knob body 130 may be disposed inside the first knob body 120 and may constitute the interior of the knob body NB. In another example, the first knob body 120 and the second knob body 130 may be integrally formed.

The first knob body 120 may include a substantially frustoconical or cylindrical knob ring 121. The knob ring 121 may be disposed to face the front plate 31. A grip portion 123 may protrude from an upper surface 122 of the knob ring 121. The grip portion 123 may protrude axially from the upper surface 122 of the knob ring 121. The grip portion 123 may serve as a portion gripped by a user. The grip portion 123 may extend in a direction perpendicular to the axial direction (see the Z-axis direction in FIG. 2). Reference numeral 123a denotes a reference mark formed on the grip portion 123. Although not shown, a reference mark may be provided even on the surface of the knob ring 121.

An end 121b of the knob ring 121 (see FIG. 8) may interfere with the safety device 200. As shown in FIG. 8, the end 121b of the knob ring 121 may contact an interference region A of the safety device 200. In this case, the entire knob body NB, including the knob ring 121, may not move in the axial direction.

The second knob body 130 may be disposed in an internal space 121a of the first knob body 120. The second knob body 130 may be fixed in the internal space 121a of the first knob body 120. The second knob body 130 may be press-fitted into the internal space 121a or fixed therein with an adhesive. Although not shown, the second knob body 130 may also be fastened to the first knob body 120 by using fasteners.

The second knob body 130 may be provided with the shaft coupling portion 131 to which one end portion of the drive shaft 71 is coupled. The shaft coupling portion 131 may have a substantially cylindrical shape. The shaft coupling portion 131 may be disposed at the center of the knob body NB. A shaft coupling hole 132 is formed in the shaft coupling portion 131, and the drive shaft 71 may be inserted into the shaft coupling hole 132. The drive shaft 71 may be fixed inside the shaft coupling hole 132 without rotating idly inside the shaft coupling hole 132.

When the one end portion of the drive shaft 71 is inserted into the shaft coupling hole 132, the drive shaft 71 may rotate together with the second knob body 130 and move in the axial direction together with the second knob body 130. That is, when the second knob body 130 is driven together with the first knob body 120, the drive shaft 71 may also be driven together. For example, when the second knob body 130 is pushed in the axial direction together with the first knob body 120, the drive shaft 71 may also move in the axial direction. When the second knob body 130 is rotated about the drive shaft 71 together with the first knob body 120, the drive shaft 71 may also be rotated. Accordingly, the drive shaft 71 may also be referred to as a rotation shaft.

The second knob body 130 may be coupled to the drive shaft 71 and may also be coupled to a weight plate 160. Accordingly, since the coupling structure with other components is implemented in the second knob body 130, the first knob body 120 may be manufactured with a relatively simple and thin structure. Accordingly, when the first knob body 120 is injection-molded, a phenomenon in which sink marks or flow marks are formed due to shrinkage of a portion of the first knob body 120 caused by its complex shape may be prevented.

The second knob body 130 may be provided with an assembly block portion 133. The assembly block portion 133 may have a substantially elongated rectangular parallelepiped structure in one direction. The assembly block portion 133 may constitute the framework of the second knob body 130. In the present embodiment, the assembly block portion 133 may have a shape corresponding to that of the grip portion 123. Accordingly, the assembly block portion 133 may be received in a fastening space 127 (see FIG. 4) provided inside the grip portion 123.

The second knob body 130 may be coupled to the weight plate 160 through fasteners B1. The fasteners B1 may pass through the weight plate 160 and then be fixed to assembly holes 134 of the second knob body 130. Accordingly, the second knob body 130 and the weight plate 160 may be assembled with each other to operate together.

The second knob body 130 may be provided with a support plate 136. The support plate 136 may protrude from the second knob body 130 toward the opposite side of the base portion 110 along the axial direction. The support plate 136 may protrude in a substantially plate-like form from the assembly block portion 133. The support plate 136 may extend in the same direction as the grip portion 123, that is, in a direction perpendicular to the axial direction. One end portion of the support plate 136 may be in close contact with the inner surface of the first knob body 120, that is, with the inner surface of the fastening space 127.

The weight plate 160, which rotates and moves together with the knob body NB, may be coupled to the knob body NB. The weight plate 160 may have a disc-shaped structure corresponding to the internal space 121a. The weight plate 160 may increase the overall weight of the knob assembly 100, thereby enhancing the operability of the knob assembly 100. To this end, the weight plate 160 may be made of a metallic material.

A shaft through-hole 161, into which the drive shaft 71 is inserted, may pass through the center of the weight plate 160. Plate fastening holes 164, through which the fasteners B1 pass, may be formed around the shaft through-hole 161. The plate fastening holes 164 may be provided as a pair.

Next, the safety device 200 will be described. The safety device 200 may limit the operation of the knob assembly 100, which moves rectilinearly in the axial direction of the drive shaft 71. By varying the position and orientation of the safety device 200, a user may selectively limit the pushing operation of the knob assembly 100. The safety device 200 may be arranged to surround the drive shaft 71 before the knob assembly 100 is coupled to the drive shaft 71. In the present embodiment, the safety device 200 may be arranged to surround the outer circumferential surface of the base portion 110. This configuration will be further described below.

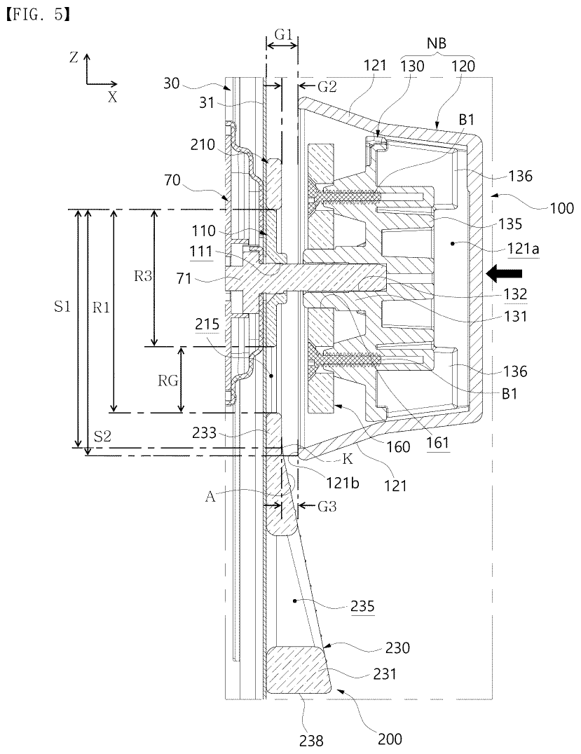

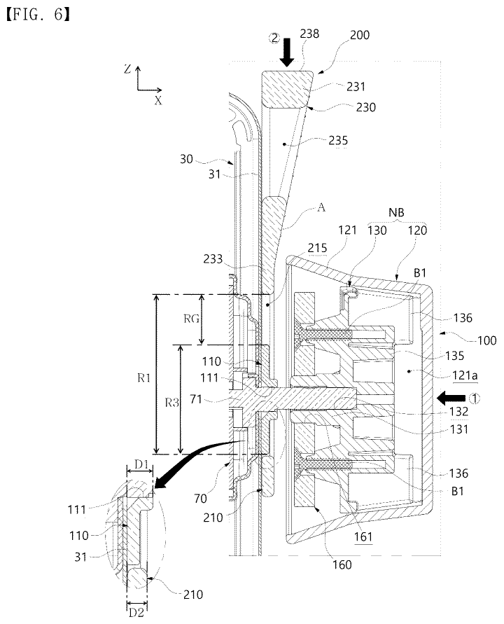

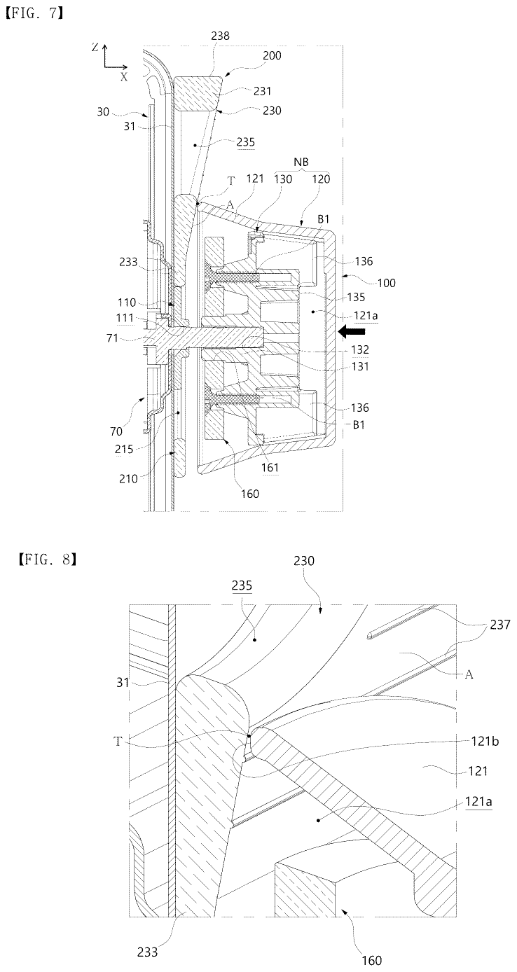

When the safety device 200 is positioned differently between the knob assembly 100 and the operation panel 30, (i) the locked state, in which the pushing of the knob assembly 100 is prevented, and (ii) the unlocked state, in which the pushing of the knob assembly 100 is allowed, may be implemented. For reference, FIG. 5 illustrates the unlocked state, and FIG. 7 illustrates the locked state.

The safety device 200 may be rotated about the drive shaft 71. The safety device 200 may include the mounting hole 215, which will be described below, through which the drive shaft 71 passes and which serves as the rotational center of the safety device 200. As the safety device 200 rotates, the safety device 200 may have the unlocked state, in which a second body portion 230 faces downward (see FIG. 5), and the locked state, in which the second body portion 230 faces upward and the interference region A is disposed between the knob assembly 100 and the operation panel 30 (see FIG. 7).

In this manner, the safety device 200 may rotate about the knob assembly 100 and the safety device 200 may be disposed at the upper end (12 o'clock position) of the knob assembly 100 in the locked state. The safety device 200 disposed at the upper end of the knob assembly 100 may be supported by the knob assembly 100, so that there is no risk of downward movement of the safety device 200 due to gravity. Therefore, after the locked state is established, the locked state may not be unintentionally released by gravity.

The safety device 200 may include a first body portion 210 and the second body portion 230. The first body portion 210 and the second body portion 230 may be connected to each other to constitute a single body. The first body portion 210 and the second body portion 230 may be integrally formed. The first body portion 210 may allow the safety device 200 to be mounted on the cooking appliance, while the second body portion 230 may serve as a portion gripped by a user and as a portion for limiting the pushing operation of the knob assembly 100.

The safety device 200 may be made of a flexible material. For example, the safety device 200 may be made of silicone or rubber. The safety device 200 may bend during rotation or movement. For instance, when the safety device 200 is rotated, the safety device 200 may interfere with a knob assembly 100 adjacent to the knob assembly 100 into which the safety device 200 is fitted. In this case, the bending of the safety device 200 allows such interference to be avoided.

The first body portion 210 may have a substantially plate-shaped structure. The first body portion 210 may have the mounting hole 215 formed therethrough. The mounting hole 215 may be formed by penetrating the first body portion 210 in the axial direction. The base portion 110 may be positioned within the mounting hole 215. When the drive shaft 71 passes through the mounting hole 215, the mounting hole 215 may serve as the rotational center of the safety device 200. In addition, the safety device 200 may be engaged with the drive shaft 71 to prevent the safety device 200 from being detached from the cooking appliance.

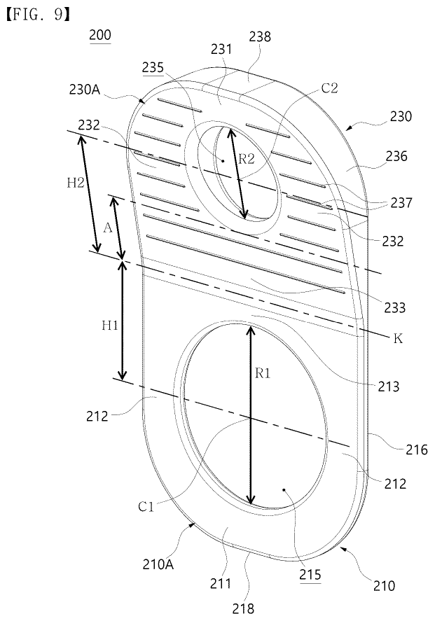

Referring to FIG. 9, around the mounting hole 215, a first end portion 213 of the first body portion 210 may be formed on one side of the first body portion 210, and a second end portion 211 of the first body portion 210 is formed on the opposite side. The first end portion 213 of the first body portion 210 may be connected to a partition portion K, which will be described below. The second end portion 211 of the first body portion 210 may face downward when the safety device 200 is in the unlocked position.

Side portions 212 of the first body portion 210 may respectively be formed on the opposite sides of the mounting hole 215. The pair of side portions 212 of the first body portion 210 may surround the opposite edges of the mounting hole 215. Each of the side portions 212 of the first body portion 210 may have the same width along the Y-axis direction orthogonal to the axial direction, or may have a width that varies along a curved shape corresponding to the mounting hole 215. Reference numeral 216 denotes the peripheral surface of the first body portion 210.

The mounting hole 215 may form a closed curve within the first body portion 210. Here, the term “closed curve” means that there is no portion of the mounting hole 215 that is open in a radial direction thereof in the entire section of the mounting hole 215 along the circumferential direction of the mounting hole 215. When the mounting hole 215 is formed as the closed curve, the mounting hole 215 may be maintained to be engaged with the drive shaft 71 and the base portion 110.

The first body portion 210 may continuously surround the edge of the mounting hole 215 along the circumferential direction of the mounting hole 215. The first end portion 213 of the first body portion 210, the second end portion 211 of the first body portion 210, and the pair of side portions 212 of the first body portion 210 may surround the edge of the mounting hole 215.

The first body portion 210 may have a uniform axial thickness throughout an entire region thereof. Because the first body portion 210 has the uniform thickness over its entire area, the safety device 200 may rotate about the mounting hole 215 at any angle without interference thereof between the knob assembly 100 and the operation panel 30. In addition, the first body portion 210 has the uniform thickness over its entire area, and thus when the safety device 200 is disposed on the operation panel 30, the extent to which the front surface 210A of the first body portion 210 protrudes from the operation panel 30 may be uniform.

The second body portion 230 may be connected to the first body portion 210. A first end portion 233 of the second body portion 230 may be connected to the first body portion 210, and a second end portion 231 of the second body portion 230 may be spaced apart from the first end portion 233 of the second body portion 230 along the longitudinal direction. Here, the longitudinal direction refers to the overall longitudinal direction of the safety device 200, which corresponds to a vertical direction (a Z-axis direction in FIG. 3) with reference to FIG. 9.

In the second body portion 230, the interference region A having an axial thickness greater than that of the first body portion 210 may be defined. The interference region A may interfere with the knob assembly 100 and the operation panel 30 to prevent the knob body NB from being pressed in the axial direction. The interference region A may be defined over the entire second body portion 230 or only a portion of the second body portion 230.

The first body portion 210 and the second body portion 230 may be partitioned by the partition portion K. With respect to the partition portion K, the first end portion 213 of the first body portion 210 and the first end portion 233 of the second body portion 230 may face each other. With respect to the partition portion K, the axial thickness of the second body portion 230 may gradually increase. A portion of the region where the axial thickness increases may serve as the interference region A.

In this embodiment, the interference region A may be defined between the partition portion K and a through hole 235. That is, the interference region A may be formed within the second body portion 230. In another example, a portion of each of the side portions 232 of the second body portion 230, which are disposed on the opposite sides of the through hole 235, may also be included in the interference region A.

Referring to FIG. 9, looking at the structure of the second body portion 230, the through hole 235 may be formed in the second body portion 230. The through hole 235 may be formed in the second body portion 230 to have a closed curve independent of the mounting hole 215. The through hole 235 may serve as a kind of handle allowing a user to more easily grip the second body portion 230. In addition, when the interference region A is compressed between the knob assembly 100 and the cooking appliance, the compressed portion may be elastically deformed in a direction in which the through hole 235 is filled. Accordingly, compression of the interference region A may further be facilitated.

The side portions 232 of the second body portion 230 may be formed on the opposite sides of the through hole 235, respectively. The pair of side portions 232 of the second body portion 230 may surround the opposite edges of the through hole 235. The side portions 232 of the second body portion 230 may have the same widths with respect to the Y-axis direction, which is perpendicular to the axial direction, or may have widths varying along a curved shape corresponding to the mounting hole 215. Reference numeral 236 denotes the peripheral surface of the second body portion 230.

The second body portion 230 may have an axial thickness that varies throughout an entire region thereof. More specifically, the axial thickness of the second body portion 230 may increase along the longitudinal direction, which is perpendicular to the axial direction. Accordingly, the second body portion 230 including the interference region A may be press-fitted between the operation panel 30 and the knob assembly 100. The thickness of the second body portion 230 may vary throughout its entire region, and thus when the safety device 200 is disposed on the operation panel 30, the extent to which the front surface 230A of the second body portion 230 protrudes from the operation panel 30 may not be uniform along the longitudinal direction.

Referring to FIG. 10, the rear surface 210B of the first body portion 210 and the rear surface 230B of the second body portion 230 may be formed as a continuous plane. The rear surface 210B of the first body portion 210 and the rear surface 230B of the second body portion 230 may be configured as planes having uniform heights. Accordingly, the entire rear surfaces 210B and 230B of the first body portion 210 and the second body portion 230 may have a wide contact area with the front plate 31.

The mounting hole 215 may be formed at a position outside the interference region A. When the mounting hole 215 is formed at the position outside the interference region A, the interference region A, which brings the knob assembly 100 into the locked state, may not have a through portion. Accordingly, a large contact area between the interference region A and the knob assembly 100 may be secured, and the safety device 200 may stably maintain a state in which the safety device 200 interferes between the knob assembly 100 and the cooking appliance.

In the present embodiment, the mounting hole 215 is formed at a position spaced apart from the partition portion K, which is the starting point of the interference region A, toward the second end portion 211 of the first body portion 210. Accordingly, the mounting hole 215 may not be involved in interference between the operation panel 30 and the knob assembly 100.

Referring to FIG. 5, in which the safety device 200 is located at the unlocked position, the safety device 200 is shown to be positioned in front of the operation panel 30. As can be seen, the safety device 200 may be disposed between the front plate 31 and the knob body NB. The inner surface of the mounting hole 215 of the safety device 200 may surround the base portion 110, and a portion of the drive shaft 71 may protrude forward through the mounting hole 215.

The edge of the mounting hole 215 may engage with the base portion 110. With reference to the drawing, the upper edge of the mounting hole 215 may engage with the upper end of the base portion 110. Accordingly, the safety device 200 may maintain a state in which the safety device 200 is engaged with the base portion 110.

As shown in FIG. 5, a first gap G1 may be formed between the end 121b of the first knob body 120, which constitutes the knob body NB, and the front plate 31. Here, the first gap G1 does not represent the total distance through which the knob body NB can be pressed in the axial direction. Since the end 121b of the first knob body 120 faces the front surface 210A of the first body portion 210 of the safety device 200, the end 121b of the first knob body 120 may contact the front surface 210A of the first body portion 210 before contacting the front plate 31. Accordingly, with reference to FIG. 5, the total distance through which the knob body NB can be pressed in the axial direction may correspond to the axial distance G2 or G3 between the end 121b of the first knob body 120 and the first body portion 210.

When the safety device 200 is located at the unlocked position, the axial distance between the surface of the first body portion 210 and the knob assembly 100 may be greater than or equal to a reference distance. With reference to FIG. 5, the axial distance G2 or G3 between the end 121b of the first knob body 120 and the first body portion 210 may be greater than or equal to an axial reference distance required for the drive shaft 71 to operate the heating drive part. Accordingly, when the safety device 200 is located at the unlocked position, a user may press the knob body NB in the axial direction to operate the heating device 28.

Referring to FIG. 5, with respect to the Z-axis direction orthogonal to the axial direction, the end 121b of the first knob body 120 may be positioned outside the interference region A. The end 121b of the first knob body 120 faces a position which is outside the interference region A and is closer to the first body portion 210 than the partition portion K.

More specifically, when the cooking appliance is in the unlocked state, a radial distance S1 between an end of the base portion 110 and the partition portion K may be shorter than a radial distance S2 between the end of the base portion 110 and the interference region A. Here, the end 121b of the first knob body 120 may face the partition portion K, or may be disposed closer to the drive shaft 71 than the partition portion K. Accordingly, in the unlocked state, even if the knob body NB is pressed in the axial direction (in the direction of the arrow in FIG. 5), the end 121b of the first knob body 120 may not interfere with the interference region A.

Meanwhile, an inner diameter R1 of the mounting hole 215 is greater than an outer diameter of the drive shaft 71 or an outer diameter R3 of the base portion 110 through which the drive shaft 71 passes. In the present embodiment, the safety device 200 may slide in a direction orthogonal to the axial direction by a difference RG between the inner diameter R1 of the mounting hole 215 and the outer diameter R3 of the base portion 110. The difference between the inner diameter R1 of the mounting hole 215 and the outer diameter R3 of the base portion 110 may be greater than or equal to a distance over which the safety device 200 moves between the locked position and the unlocked position. Referring to FIG. 5, the safety device 200 may rectilinearly move in the Z-axis direction by the difference RG. Such a clearance distance RG may facilitate operation of the safety device 200 and may allow the safety device 200 to be applicable to cooking appliances of various specifications.

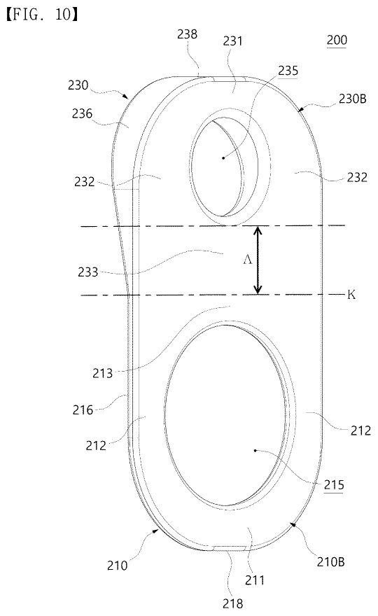

For reference, in FIG. 11, the inner diameter R1 of the mounting hole 215 and the outer diameter R3 of the base portion 110 are compared. As such, when the center C1 of the mounting hole 215 and the center of the base portion 110 are concentrically aligned, an entire inner circumferential surface of the mounting hole 215 may be spaced apart from an entire outer circumferential surface of the base portion 110.

FIG. 6 shows a state in which the safety device 200 is rotated 180 degrees about the drive shaft 71. In FIG. 6, the knob body NB is still spaced apart from the surface of the safety device 200 in the axial direction. Therefore, the knob body NB may be pressed in the axial direction (in the direction of arrow \textcircled{1}).

The axial thickness D2 of the first body portion 210 may be smaller than or equal to the axial thickness D1 of the base portion 110. Referring to the enlarged portion of FIG. 6, the thickness D1 of the base portion 110 is greater than the thickness D2 of the first body portion 210. Therefore, with respect to the unlocked state, the knob assembly 100 may first interfere with the base portion 110 in the axial direction before the knob assembly 100 interferes with the safety device 200.

Meanwhile, in FIG. 6, the safety device 200 may slide in the direction orthogonal to the axial direction (in the direction of arrow \textcircled{2}) by the difference RG between the inner diameter R1 of the mounting hole 215 and the outer diameter R3 of the base portion 110. Here, the direction orthogonal to the axial direction is the same as the gravitational direction. When the safety device 200 moves in the direction orthogonal to the axial direction (in the direction of arrow \textcircled{2}), the interference region A may fill the gap between the knob body NB and the front plate 31. As a result, the knob body NB may not move in the axial direction (in the direction of arrow \textcircled{1}), and the cooking appliance may be in the locked state.

Such a state is shown in FIG. 7. When the safety device 200 moves to the locked position, the interference region A of the safety device 200 may be disposed between the knob body NB and the front plate 31. Accordingly, the knob body NB may not be pressed in the axial direction (in the direction of the arrow in FIG. 7), and the heating device 28 may not be operated.

With reference to FIG. 7, the upper end of the first knob body 120 may interfere with the interference region A. Reference numeral T indicates an interference point between the upper end of the first knob body 120 and the interference region A. The interference point T may be formed between the through hole 235 and the mounting hole 215.

In FIG. 8, which shows an enlarged view of the interference point T, the end 121b of the first knob body 120 may be in contact with the surface of the interference region A. Since the interference point T is formed between the through hole 235 and the mounting hole 215, an interference area may not be reduced by the holes 215 and 235. As such, because the interference area is sufficiently secured, the interference state may be maintained more stably.

Referring to FIGS. 9 to 11, a length between the partition portion K and the second end portion 211 of the first body portion 210 that is spaced farthest from the partition portion K may be longer than a length between the partition portion K and the second end portion 231 of the second body portion 230 that is spaced farthest from the partition portion K. That is, on the basis of the comparison of lengths from the partition portion K, the length X1 of the first body portion 210 (see FIG. 11) may be longer than the length X2 of the second body portion 230 (see FIG. 11). This is because the first body portion 210 is designed to secure the large diameter R1 of the mounting hole 215 to accommodate various sizes of the knob assembly 100 and the base portion 110. In addition, by making the length of the second body portion 230 shorter than that of the first body portion 210, the area of the second body portion 230 exposed upward in the locked position may be reduced.

In the present embodiment, the diameter R1 of the mounting hole 215 may be larger than the diameter R2 of the through hole 235. The through hole 235 may not be involved in the mounting of the safety device 200 but may function to facilitate the grip of a user, and accordingly, the diameter R2 of the through hole 235 may not be required to be as large as the diameter R1 of the mounting hole 215.

The through hole 235 may have the closed curve independent of the mounting hole 215. The through hole 235 may not be open in any one direction along the radial direction. When the through hole 235 has the closed curve shape, a user may hold the through hole 235 with a finger and apply strong external force to pull the safety device 200.

A distance H1 between the partition portion K and the center C1 of the mounting hole 215 may be longer than the distance H2 between the partition portion K and the center C2 of the through hole 235. In this case, when the safety device 200 is mounted on the operation panel 30, the through hole 235 may be exposed to the outside of the knob assembly 100. By sufficiently securing the distance H1 between the partition portion K and the center C1 of the mounting hole 215, the through hole 235 and the second end portion 231 of the second body portion 230 may be exposed to a user.

The distance between the second end portion 211 of the first body portion 210, which is spaced farthest from the partition portion K, and the center C1 of the mounting hole 215 may be longer than the distance between the partition portion K and the center C1 of the mounting hole 215. When the safety device 200 has such a structure, even if the safety device 200 is applied to the base portion 110 of various sizes, the through hole 235 may be exposed radially outside the knob assembly 100.

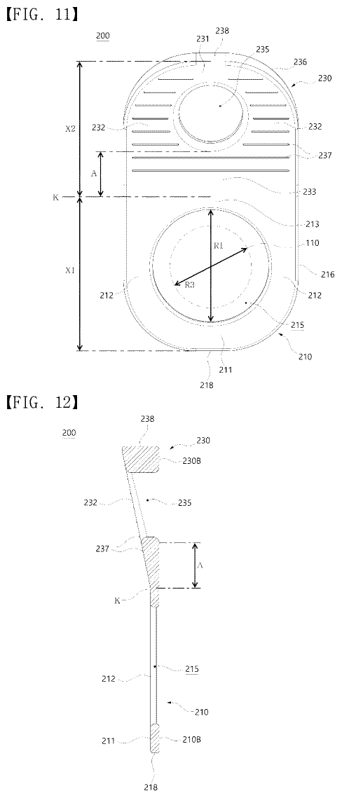

The interference region A may have different axial thicknesses along the longitudinal direction. Referring to FIG. 12, the interference region A may have different thicknesses along the longitudinal direction between the partition portion K and the through hole 235. More specifically, the interference region A may have a thickness that gradually increases toward a position away from the partition portion K. Accordingly, when a user pushes the interference region A between the knob body NB and the front plate 31, an insertion force required may be distributed.

The interference region A may be defined between the edge of the mounting hole 215 and the edge of the through hole 235. As shown in FIG. 9, in the present embodiment, the interference region A may be provided between the edge of the mounting hole 215 and the edge of the through hole 235. Here, the edge of the mounting hole 215 and the edge of the through hole 235 respectively refer to the first end portions facing the partition portion K.

The interference region A may be defined between a position spaced apart from the edge of the mounting hole 215 toward the second body portion 230 and the second end portion 231 of the second body portion 230. Depending on the relative sizes of the second body portion 230 and the knob assembly 100, the interference region A may extend entirely from the edge of the mounting hole 215 to the second end portion 231 of the second body portion 230.

The center C1 of the mounting hole 215 and the center C2 of the through hole 235 may be aligned along the longitudinal direction of the first body portion 210 and the second body portion 230. As shown in FIGS. 9 and 11, the center C1 of the mounting hole 215 and the center C2 of the through hole 235 may be disposed on the same extension line along the longitudinal direction of the safety device 200. In this case, the safety device 200 may have a left-right symmetrical structure with respect to the mounting hole 215 and the through hole 235, so that the safety device 200 may be easily operated by a user from both left and right sides.

The second body portion 230 may be provided with a plurality of protruding portions 237. The protruding portions 237 may protrude from the front surface 230A of the second body portion 230. The protruding portions 237 may increase friction when a user grips the second body portion 230, thereby facilitating the grip. The protruding portions 237 may also be provided on the interference region A and may serve to increase friction between the interference region A and the surface of the knob body NB.

The plurality of protruding portions 237 may be provided on the second body portion 230 to be spaced apart from each other along the longitudinal direction of the second body portion 230. Each of the protruding portions 237 may have a shape of a rib extending in one direction, with each of the ribs spaced apart from each other. The protruding portion 237 may be formed in a direction orthogonal to the longitudinal direction of the safety device 200. Alternatively, each of the protruding portions 237 may be formed in the longitudinal direction of the safety device 200 or formed in an inclined direction. In another example, the protruding portions 237 may be omitted.

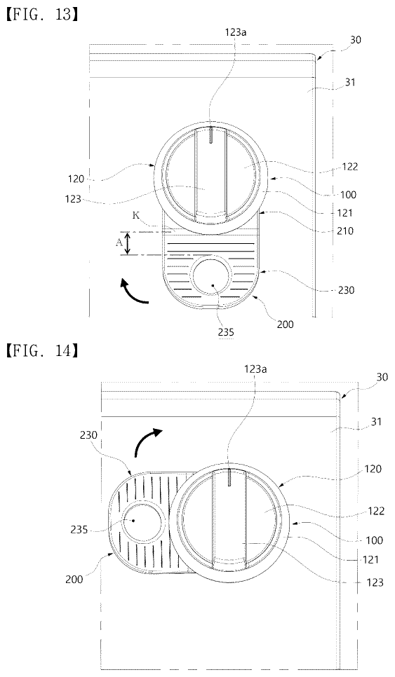

Referring to FIGS. 13 to 16, the process of switching the safety device 200 from the unlocked position to the locked position will be described. First, FIG. 13 shows the safety device 200 disposed at the unlocked position. In the unlocked position, the first body portion 210 of the safety device 200 may face downward, and the second body portion 230 thereof may face upward. When a user does not operate the safety device 200, the second body portion 230 may face downward due to gravity. This position of the safety device 200 may be referred to as a first position.

In this case, due to the thickness of the second body portion 230, the relatively heavy second body portion 230 may face downward due to gravity with the mounting hole 215 as a rotation center, and thus may be in the unlocked state. In this way, the safety device 200 of the present embodiment may basically have the unlocked position, and the safety device 200 may be rotated to the locked position only when a user requires.

As shown in FIG. 13, a portion or the entirety of the interference region A may be exposed downward from the knob assembly 100. Therefore, a user may recognize that the safety device 200 has not yet limited the pressing of the knob assembly 100. The entirety of the through hole 235 may be exposed downward from the knob assembly 100, allowing a user to easily grip the through hole 235.

The FIG. 14 shows that the safety device 200 is rotated clockwise by 90 degrees. A user may grip the through hole 235 and rotate the safety device 200. In this case, the mounting hole 215 may serve as the center of rotation. As shown in FIG. 14, when a user moves the safety device 200 in the direction toward the drive shaft 71 (to the right on the basis of the drawing), the interference region A may be press-fitted between the knob body NB and the front plate 31. However, in this case, the interference may not be strongly pressed, or the safety device 200 may be restored to the state of FIG. 13 by gravity over time.

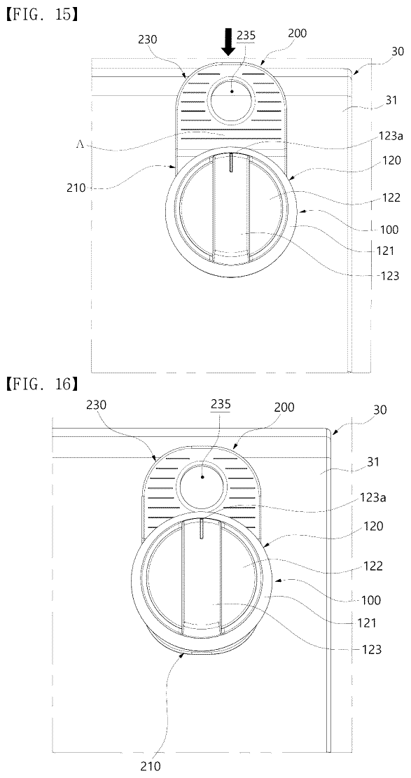

FIG. 15 shows a state where the safety device 200 is further rotated clockwise by 90 degrees from the state shown in FIG. 14. In this case, the second body portion 230 faces the 12 o'clock position. In this state, the safety device 200 may move in the vertical direction. This movement is possible because the inner diameter R1 of the mounting hole 215 is larger than the outer diameter R3 of the base portion 110. The position of the safety device 200 in the state shown in FIG. 15 may be referred to as a second position.

When a user presses the safety device 200 in the direction of the arrow in FIG. 15, the safety device 200 may be switched to the state shown in FIG. 16. That is, the interference region A of the safety device 200 may be inserted between the knob body NB and the front plate 31 and may be in the locked state. Referring to FIG. 16, most of the interference region A may be hidden by the knob body NB. Therefore, a user may see this state and realize that the cooking appliance is in the locked state. This position of the safety device 200 may be referred to as a third position of the safety device 200.

In this case, the safety device 200 may be positioned at the upper end (12 o'clock position) of the knob assembly 100. Since the safety device 200 positioned at the upper end of the knob assembly 100 is supported by the knob assembly 100, there is no risk of downward movement of the safety device 200 due to gravity. Accordingly, the safety device 200 may be prevented from rotating due to gravity and the locked state of the cooking appliance may be prevented from being released unintentionally.

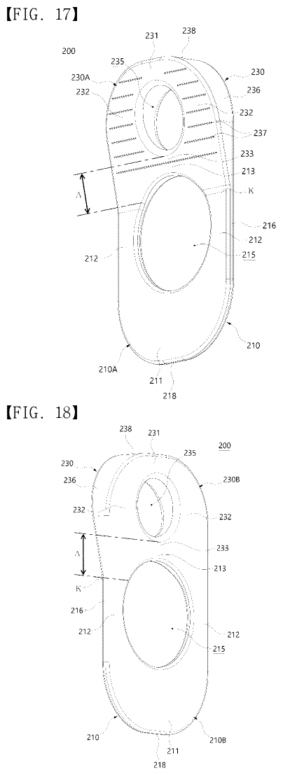

FIGS. 17 and 18 are perspective views illustrating the configuration of a safety device 200 for a cooking appliance according to a second embodiment of the present disclosure, as viewed from different angles. A detailed description of structures identical to those of the previous embodiment will be omitted, and only different structures will be described below. In the present embodiment, a mounting hole 215 may be formed in a first body portion 210. A through hole 235 may be formed in a second body portion 230 connected to the first body portion 210.

The interference region A having an axial thickness increasing from the partition portion K may be defined in the second body portion 230. In this case, a portion of the mounting hole 215 may overlap with the interference region A. As shown in FIG. 17, a portion of the mounting hole 215 may be surrounded by the interference region A. However, most of the mounting hole 215 may be disposed in the first body portion 210 outside the interference region A. More specifically, two-thirds of the mounting hole 215 or more may be disposed outside the interference region A.

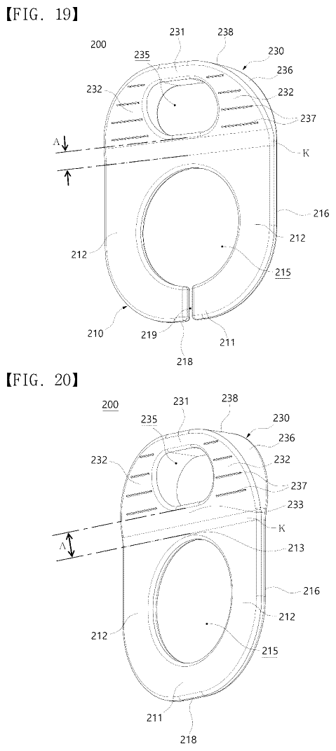

FIG. 19 is a perspective view illustrating the configuration of a safety device 200 for a cooking appliance according to a third embodiment of the present disclosure. Descriptions of structures identical to those of the previous embodiments are omitted, and only differing structures will be described. In the present embodiment, a mounting hole 215 may be formed in a first body portion 210. The mounting hole 215 may be formed at a position outside the interference region A.

A portion of the mounting hole 215 may be open in the radial direction. A slit portion 218 may be formed in the open portion of the mounting hole 215. The slit portion 218 may be formed in the radial direction of the mounting hole 215. In the present embodiment, the slit portion 218 may be formed in the longitudinal direction of the safety device 200. A first end of the slit portion 218 may be connected to the mounting hole 215, and a second end of the slit portion 218 may be connected to the second end of the first body portion 210. The slit portion 218 may allow the safety device 200 to be separated from the cooking appliance without removing the knob assembly 100. In another example, the slit portion 218 may be formed at a different angle along the circumferential direction of the mounting hole 215.

A through hole 235 may be formed in a second body portion 230 connected to the first body portion 210. In this case, the through hole 235 may have an elliptical shape elongated in one direction rather than a circular shape. In the present embodiment, the through hole 235 may be longer in a left-right direction orthogonal to the longitudinal direction of the safety device 200.

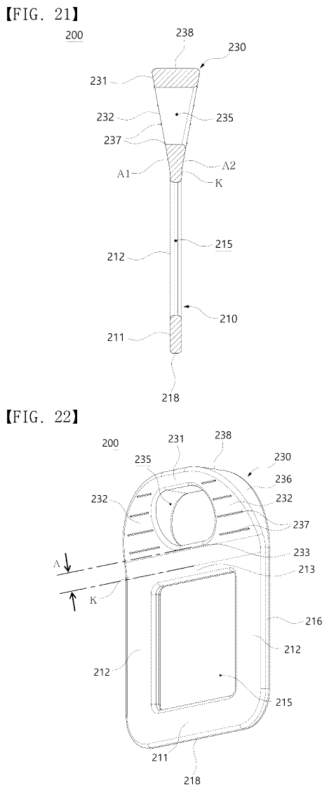

FIGS. 20 and 21 respectively show a perspective view and a cross-sectional view of a configuration of a safety device 200 for a cooking appliance according to a fourth embodiment of the present disclosure. Descriptions of structures identical to those of the previous embodiments are omitted, and only differing structures will be described.

In the present embodiment, a mounting hole 215 may be formed in a first body portion 210. The mounting hole 215 may be formed at a position outside an interference region A. A second body portion 230 in which a through hole 235 is formed may be connected to the first body portion 210.

With respect to a reference line extending in the longitudinal direction of the first body portion 210 and the second body portion 230, the second body portion 230 may have a symmetrical structure in the axial direction. Here, the axial direction corresponds to the front-rear direction on the basis of FIG. 21. As shown in FIG. 21, the second body portion 230 may have a structure in which the thickness thereof increases in the front-rear direction.

The interference region A may include a first interference region A1 and a second interference region A2. Accordingly, when the interference region A includes the interference regions configured as a symmetrical pair, the safety device 200 may have no directionality with respect to the axial direction. Accordingly, when mounting the safety device 200 to the cooking appliance, a user may mount the safety device 200 in opposite directions without any specific orientation.

FIG. 22 shows a perspective view of the configuration of a safety device 200 for a cooking appliance according to a fifth embodiment of the present disclosure. Descriptions of structures identical to those of the previous embodiments are omitted, and only differing structures will be described. As shown in FIG. 22, a rectangular mounting hole 215 may be formed in a first body portion 210. The vertical and horizontal lengths of the mounting hole 215 may each be greater than the outer diameter of the base portion 110. In another example, the mounting hole 215 may have an elliptical, triangular, or polygonal shape having five or more sides instead of a rectangular shape.

FIG. 23 shows a perspective view of the configuration of a safety device 200 for a cooking appliance according to a sixth embodiment of the present disclosure. Descriptions of structures identical to those of the previous embodiments are omitted, and only differing structures will be described. As shown in FIG. 23, a second body portion 230 may be provided with a handle portion 238 protruding in a direction opposite to a direction toward a first body portion 210. The handle portion 238 may be a part gripped by a user. The handle portion 238 may have a ring shape. A holding recess 235 may be formed in the handle portion 238 to facilitate the grip of a user.

In the present embodiment, the handle portion 238 may have an asymmetrical structure. With reference to FIG. 23, the handle portion 238 may be provided at a position offset to the right from the center of the second body portion 230. In another example, the handle portion 238 may be provided at a position offset to the left from the center of the second body portion 230. In still another example, the handle portion 238 may protrude upward from the center of the second body portion 230.

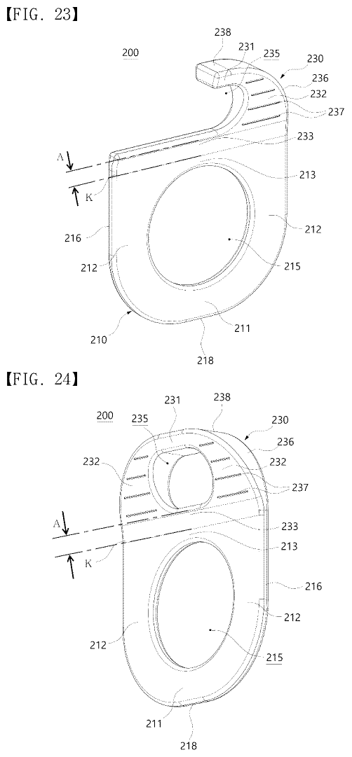

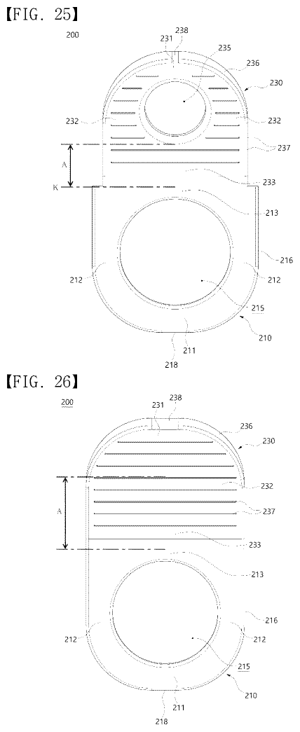

FIG. 24 shows a perspective view of the configuration of a safety device 200 for a cooking appliance according to a seventh embodiment of the present disclosure. Descriptions of structures identical to those of the previous embodiments are omitted, and only differing structures will be described. The interference region A does not include the protruding portions 237. The interference region A having a sloped or curved surface structure without the protruding portions 237, may increase the contact area with the knob body NB.

FIG. 25 shows a perspective view of the configuration of a safety device 200 for a cooking appliance according to an eighth embodiment of the present disclosure. Descriptions of structures identical to those of the previous embodiments are omitted, and only differing structures will be described. With respect to a width in a direction orthogonal to the longitudinal direction of the first body portion 210 and the second body portion 230, the first body portion 210 and the second body portion 230 may respectively have different widths. More specifically, the lateral width of the first body portion 210 may be greater than that of the second body portion 230.

FIG. 26 shows a perspective view of the configuration of a safety device 200 for a cooking appliance according to a ninth embodiment of the present disclosure. Descriptions of structures identical to those of the previous embodiments are omitted, and only differing structures will be described. A mounting hole 215 is formed in a first body portion 210, and the second body portion 230 may not have a through structure. That is, the second body portion 230 may entirely serve as a grip portion without the through structure.

Meanwhile, although not shown, the thickness of the interference region A may not gradually increase along the longitudinal direction of the safety device 200. For example, the thickness of the interference region A may increase stepwise along the longitudinal direction of the safety device 200. In addition, the interference region A may be formed only of portions having two different thicknesses. In another example, the interference region A may have a single uniform thickness greater than the thickness of the first body portion 210. In still another example, the interference region A may be formed of a plurality of protrusions having thicknesses greater than the thickness of the first body portion 210.

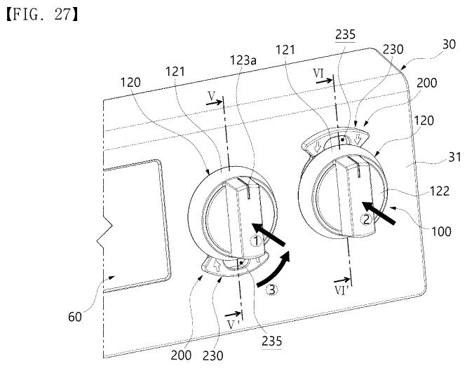

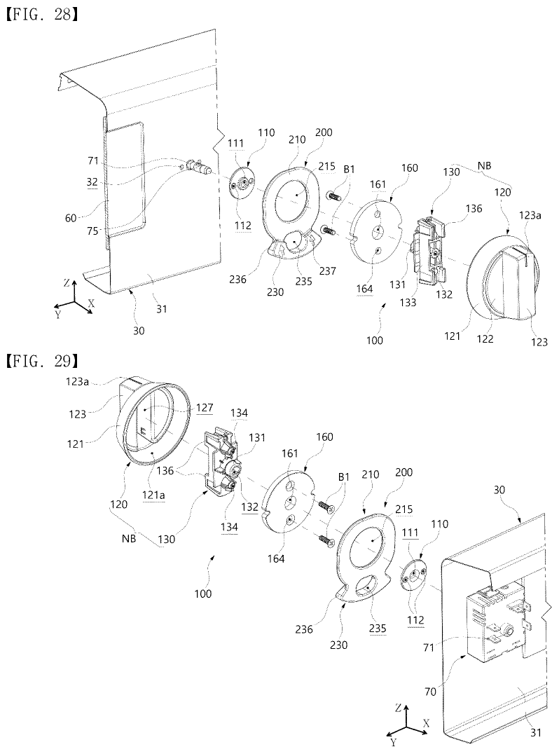

Next, with reference to FIGS. 27 to 42, a tenth embodiment of the present disclosure will be described. A user may control the heating device 28 by pressing and then rotating the knob assembly 100. In this case, as shown in FIG. 27, to prevent the knob assembly 100 from being unintentionally operated due to the error of a user or interference thereof with surrounding objects, the present disclosure provides a safety device for a cooking appliance (hereinafter referred to as “a safety device 200”). Hereinafter, the cooking appliance will be described focusing on the safety device 200 and a malfunction-prevention structure. However, the same reference numerals are assigned to structures identical to those of the previous embodiments, and detailed descriptions thereof are omitted.

As shown in FIG. 27, in the present embodiment, the safety device 200 may be disposed between the knob assembly 100 and the operation panel 30. The safety device 200 may prevent the knob assembly 100 from being pressed in the axial direction. When the safety device 200 limits the axial movement of the knob assembly 100, the operation of the heating drive part through the knob assembly 100 may also be impossible. For the operation of the heating drive part, the knob assembly 100 may be required to be first pressed and then rotated, but the pressing of the knob assembly 100, which is the first step, may be prevented. Accordingly, the safety device 200 may prevent the unintended operation of the cooking appliance.

In this case, the safety device 200 may create the locked state, which prevents the knob assembly 100 from being pressed, and the unlocked state, which allows the knob assembly 100 to be pressed, by changing its position between the knob assembly 100 and the operation panel 30. When the safety device 200 is disposed at the locked position, the locked state thereof may be implemented, and when the safety device 200 is disposed at the unlocked position, the unlocked state thereof may be implemented. This structure will be described in detail below.

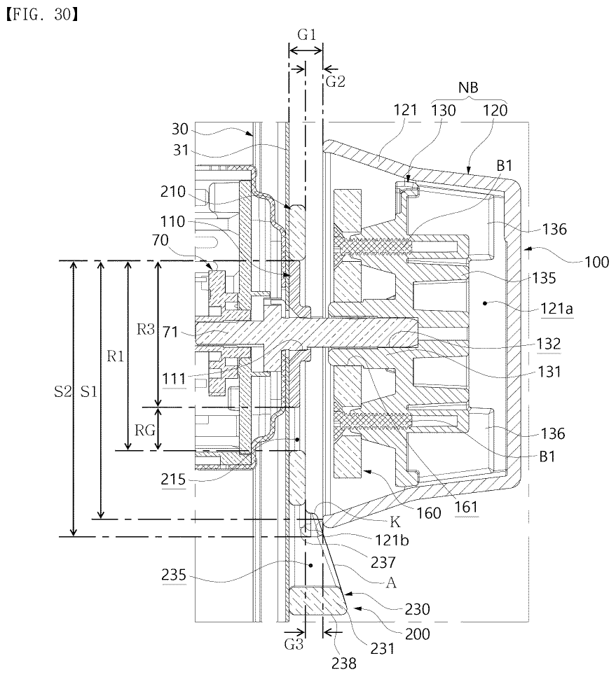

Looking at the detailed structure of the knob assembly 100, FIGS. 28 and 29 show the components of the knob assembly 100 in an exploded view. For convenience of description, the drive shaft 71 will be described first. The drive shaft 71 may be coupled to the knob assembly 100. The drive shaft 71 may be coupled to the heating drive part 70 so as to be pushable and rotatable. In this case, the heating drive part 70 may prevent the drive shaft 71 from rotating when the drive shaft 71 is not pushed. As the drive shaft 71 is pushed and rotated relative to the heating drive part 70, the heating drive part 70 may supply energy to the heating device 28. This configuration may be the same as that of the previous embodiments.

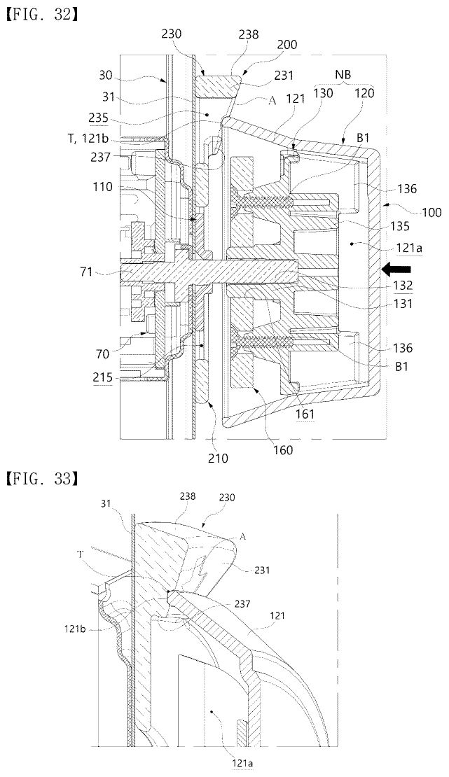

Next, the safety device 200 will be described. When the safety device 200 is positioned differently between the knob assembly 100 and the operation panel 30, (i) the locked state, in which pressing of the knob assembly 100 is prevented, and (ii) the unlocked state, in which pressing of the knob assembly 100 is allowed, may be implemented. For reference, FIG. 30 shows the unlocked state, and FIG. 32 shows the locked state.

The safety device 200 may be rotated about the drive shaft 71. The safety device 200 may include the mounting hole 215, which will be described below, through which the drive shaft 71 passes and which serves as the rotational center of the safety device 200. As the safety device 200 rotates, the safety device 200 may have the unlocked state, in which the second body portion 230 faces downward (see FIG. 30), and the locked state, in which the second body portion 230 faces upward and an interference region A is disposed between the knob assembly 100 and the operation panel 30 (see FIG. 32).

In this manner, the safety device 200 may rotate about the knob assembly 100 and the safety device 200 may be disposed at the upper end (12 o'clock position) of the knob assembly 100 in the locked state. The safety device 200 disposed at the upper end of the knob assembly 100 may be supported by the knob assembly 100, so that there is no risk of downward movement of the safety device 200 due to gravity. Therefore, after the locked state is established, the locked state may not be unintentionally released by gravity.

The safety device 200 may include the first body portion 210 and the second body portion 230. The first body portion 210 and the second body portion 230 may be connected to each other to constitute a single body. The first body portion 210 and the second body portion 230 may be integrally formed. The first body portion 210 may allow the safety device 200 to be mounted on the cooking appliance, while the second body portion 230 may serve as a portion gripped by a user and as a portion for limiting the pushing operation of the knob assembly 100.

The safety device 200 may be made of a flexible material. For example, the safety device 200 may be made of silicone or rubber. The safety device 200 may bend during rotation or movement. For instance, when the safety device 200 is rotated, the safety device 200 may interfere with a knob assembly 100 adjacent to the knob assembly 100 into which the safety device 200 is fitted. In this case, the bending of the safety device 200 allows such interference to be avoided.

The first body portion 210 may have a substantially plate-shaped structure. The first body portion 210 may have the mounting hole 215 formed therethrough. The mounting hole 215 may be formed by penetrating the first body portion 210 in the axial direction. The base portion 110 may be positioned within the mounting hole 215. When the drive shaft 71 passes through the mounting hole 215, the mounting hole 215 may serve as the rotational center of the safety device 200. In addition, the safety device 200 may be engaged with the drive shaft 71 to prevent the safety device 200 from being detached from the cooking appliance.

Referring to FIG. 34, around the mounting hole 215, the first end portion 213 of the first body portion 210 may be formed on one side of the first body portion 210, and the second end portion 211 of the first body portion 210 is formed on the opposite side. The first end portion 213 of the first body portion 210 may be connected to a stepped portion 237, which will be described below. The second end portion 211 of the first body portion 210 may face downward when the safety device 200 is in the unlocked position.

The side portions 212 of the first body portion 210 may respectively be formed on opposite sides of the mounting hole 215. The pair of side portions 212 may surround the opposite edges of the mounting hole 215. Each of the side portions 212 of the first body portion 210 may have the same width along the Y-axis direction orthogonal to the axial direction, or may have a width that varies along a curved shape corresponding to the mounting hole 215. Reference numeral 216 denotes the peripheral surface of the first body portion 210.

The mounting hole 215 may form a closed curve within the first body portion 210. Here, the term “closed curve” means that there is no portion of the mounting hole 215 that is open in a radial direction thereof in the entire section of the mounting hole 215 along the circumferential direction of the mounting hole 215. When the mounting hole 215 is formed as the closed curve, the mounting hole 215 may be maintained to be engaged with the drive shaft 71 and the base portion 110.

The first body portion 210 may continuously surround the edge of the mounting hole 215 along the circumferential direction of the mounting hole 215. The first end portion 213 of the first body portion 210, the second end portion 211 of the first body portion 210, and the pair of side portions 212 of the first body portion 210 may surround the edge of the mounting hole 215.

The first body portion 210 may have a uniform axial thickness throughout the entire region thereof. Because the first body portion 210 has the uniform thickness over its entire area, the safety device 200 may rotate about the mounting hole 215 at any angle without interference thereof between the knob assembly 100 and the operation panel 30. In addition, the first body portion 210 has the uniform thickness over its entire area, and thus when the safety device 200 is disposed on the operation panel 30, the extent to which the front surface 210A of the first body portion 210 protrudes from the operation panel 30 may be uniform.

The second body portion 230 may be connected to the first body portion 210. The first end portion of the second body portion 230 may be connected to the first body portion 210, and the second end portion 231 of the second body portion 230 may be spaced apart from the first end portion of the second body portion 230 along the longitudinal direction. Here, the longitudinal direction refers to the overall longitudinal direction of the safety device 200, which, with reference to FIG. 34, corresponds to the vertical direction (the Z-axis direction in FIG. 28).

As shown in FIG. 32, the interference region A having an axial thickness greater than that of the first body portion 210 may be defined in the second body portion 230. The interference region A may interfere with the knob assembly 100 and the operation panel 30, thereby preventing the knob body NB from being pressed in the axial direction. The interference region A may be defined over the entire second body portion 230 or in a portion of the second body portion 230.

The first body portion 210 and the second body portion 230 may be partitioned by the stepped portion 237. With respect to the stepped portion 237, the first end portion 213 of the first body portion 210 and the first end portion of the second body portion 230 may face each other. With respect to the stepped portion 237, the axial thickness of the second body portion 230 may gradually increase. A portion of a region where the axial thickness increases may serve as the interference region A.

In this embodiment, the interference region A may be defined between the stepped portion 237 and the second end portion 231 of the second body portion 230. That is, the interference region A may be formed within the second body portion 230. A portion of each of the side portions 232 of the second body portion 230, which are disposed on the opposite sides of the through hole 235, may also be included in the interference region A.

Referring to FIG. 34, looking at the structure of the second body portion 230, the through hole 235 may be formed in the second body portion 230. More specifically, a portion of the through hole 235 may be formed in the first body portion 210, and the remaining portion thereof may be formed in the second body portion 230. That is, the through hole 235 may be formed at the boundary portion. Accordingly, stepped portions 237, which will be described later, may be disposed on the opposite sides of the through hole 235. In another example, the through hole 235 may be formed only in a region of the second body portion 230.

The through hole 235 may be formed in the second body portion 230 to have a closed curve that is independent of the mounting hole 215. The through hole 235 may serve as a kind of handle allowing a user to more easily grip the second body portion 230. In addition, when the interference region A is compressed between the knob assembly 100 and the cooking appliance, the compressed portion may be elastically deformed in a direction in which the through hole 235 is filled. Accordingly, the compression of the interference region A may further be facilitated.

The side portions 232 of the second body portion 230 may be formed on the opposite sides of the through hole 235, respectively. The pair of side portions 232 of the second body portion 230 may surround the opposite edges of the through hole 235. The side portions 232 of the second body portion 230 may have the same widths with respect to the Y-axis, which is perpendicular to the axial direction, or may have widths which varies along a curved shape corresponding to the mounting hole 215. Reference numeral 236 denotes the peripheral surface of the second body portion 230.

The axial thickness of the second body portion 230 may vary throughout the entire region thereof. More specifically, the axial thickness of the second body portion 230 may increase along the longitudinal direction, which is perpendicular to the axial direction. Accordingly, the second body portion 230 including the interference region A may be press-fitted between the operation panel 30 and the knob assembly 100. The thickness of the second body portion 230 may vary throughout its entire region, and thus when the safety device 200 is disposed on the operation panel 30, the extent to which the front surface 230A of the second body portion 230 protrudes from the operation panel 30 may not be uniform along the longitudinal direction.

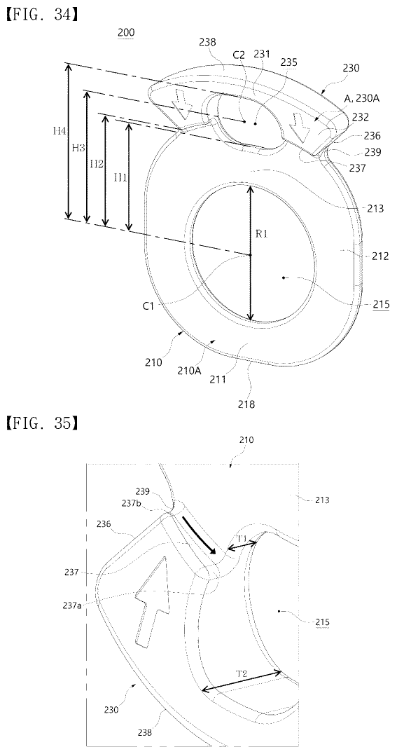

Referring to FIG. 35, the rear surface 210B of the first body portion 210 and the rear surface 230B of the second body portion 230 may be formed as a continuous plane. The rear surface 210B of the first body portion 210 and the rear surface 230B of the second body portion 230 may be configured as planes having uniform heights. Accordingly, the entire rear surfaces 210B and 230B of the first and second body portions 210 and 230 may have a wide contact area with the front plate 31.

The mounting hole 215 may be formed at a position outside the interference region A. When the mounting hole 215 is formed at the position outside the interference region A, the interference region A, which brings the knob assembly 100 into the locked state, may not have a through portion. Accordingly, a large contact area between the interference region A and the knob assembly 100 may be secured, and the safety device 200 may stably maintain a state in which the safety device 200 interferes between the knob assembly 100 and the cooking appliance.

In the present embodiment, the mounting hole 215 is formed at a position spaced apart from the stepped portion 237, which is the starting point of the interference region A, toward the second end portion 211 of the first body portion 210. Accordingly, the mounting hole 215 may not be involved in interference between the operation panel 30 and the knob assembly 100.

Referring to FIG. 30, in which the safety device 200 is located at the unlocked position, the safety device 200 is shown to be positioned in front of the operation panel 30. As can be seen, the safety device 200 may be disposed between the front plate 31 and the knob body NB. The inner surface of the mounting hole 215 of the safety device 200 may surround the base portion 110, and a portion of the drive shaft 71 may protrude forward through the mounting hole 215.

The edge of the mounting hole 215 may engage with the base portion 110. With reference to the drawing, the upper edge of the mounting hole 215 may engage with the upper end of the base portion 110. Accordingly, the safety device 200 may maintain a state in which the safety device 200 is engaged with the base portion 110.

As shown in FIG. 30, the first gap G1 may be formed between the end 121b of the first knob body 120, which constitutes the knob body NB, and the front plate 31. Here, the first gap G1 does not represent the total distance through which the knob body NB can be pressed in the axial direction. Since the end 121b of the first knob body 120 faces the front surface 210A of the first body portion 210 of the safety device 200, the end 121b of the first knob body 120 may contact the front surface 210A of the first body portion 210 before contacting the front plate 31. Accordingly, with reference to FIG. 30, the total distance through which the knob body NB can be pressed in the axial direction may correspond to the axial distance G2 or G3 between the end 121b of the first knob body 120 and the first body portion 210.

When the safety device 200 is located at the unlocked position, the axial distance between the surface of the first body portion 210 and the knob assembly 100 may be greater than or equal to the reference distance. With reference to FIG. 30, the axial distance G2 or G3 between the end 121b of the first knob body 120 and the first body portion 210 may be greater than or equal to the axial reference distance required for the drive shaft 71 to operate the heating drive part. Accordingly, when the safety device 200 is located at the unlocked position, a user may press the knob body NB in the axial direction to operate the heating device 28.

Referring to FIG. 30, with respect to the Z-axis direction orthogonal to the axial direction, the end 121b of the first knob body 120 may be positioned outside the interference region A. The end 121b of the first knob body 120 may face a position which is outside the interference region A and is closer to the first body portion 210 than the stepped portion 237.

More specifically, when the cooking appliance is in the unlocked state, the radial distance S1 between the end of the base portion 110 and the stepped portion 237 may be shorter than the radial distance S2 between the end of the base portion 110 and the interference region A. Here, the end 121b of the first knob body 120 may face the stepped portion 237, or may be disposed closer to the drive shaft 71 than the stepped portion 237. Accordingly, in the unlocked state, even if the knob body NB is pressed in the axial direction (in the direction of the arrow in FIG. 30), the end 121b of the first knob body 120 may not interfere with the interference region A.

Meanwhile, an inner diameter R1 of the mounting hole 215 may be greater than the outer diameter of the drive shaft 71 or the outer diameter R3 of the base portion 110 through which the drive shaft 71 passes. In the present embodiment, the safety device 200 may slide in a direction orthogonal to the axial direction by a difference RG between the inner diameter R1 of the mounting hole 215 and the outer diameter R3 of the base portion 110. The difference between the inner diameter R1 of the mounting hole 215 and the outer diameter R3 of the base portion 110 may be greater than or equal to a distance over which the safety device 200 moves between the locked position and the unlocked position. Referring to FIG. 30, the safety device 200 may rectilinearly move in the Z-axis direction by the difference RG. Such a clearance distance RG may facilitate operation of the safety device 200 and may allow the safety device 200 to be applicable to cooking appliances of various specifications.

For reference, in FIG. 30, the inner diameter R1 of the mounting hole 215 and the outer diameter R3 of the base portion 110 are compared. As such, when the center C1 of the mounting hole 215 and the center of the base portion 110 are concentrically aligned, the entire inner circumferential surface of the mounting hole 215 may be spaced apart from the entire outer circumferential surface of the base portion 110.

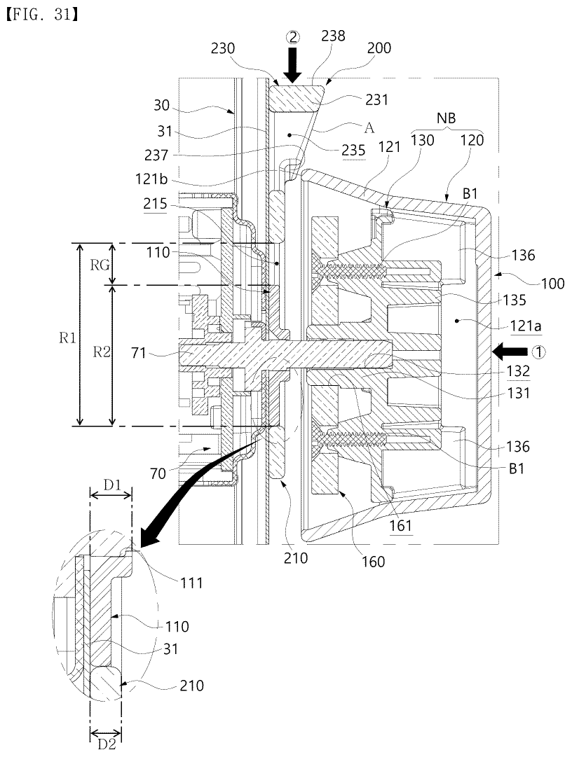

FIG. 31 shows a state in which the safety device 200 is rotated 180 degrees about the drive shaft 71. In FIG. 31, the knob body NB is still spaced apart from the surface of the safety device 200 in the axial direction. Therefore, the knob body NB may be pressed in the axial direction (in the direction of arrow \textcircled{1}).

The axial thickness D2 of the first body portion 210 may be smaller than or equal to the axial thickness D1 of the base portion 110. Referring to the enlarged portion of FIG. 31, the thickness D1 of the base portion 110 is greater than the thickness D2 of the first body portion 210. Therefore, with respect to the unlocked state, the knob assembly 100 may first interfere with the base portion 110 in the axial direction before the knob assembly 100 interferes with the safety device 200.

Meanwhile, in FIG. 31, the safety device 200 may slide in the direction orthogonal to the axial direction (in the direction of arrow \textcircled{2}) by the difference RG between the inner diameter R1 of the mounting hole 215 and the outer diameter R3 of the base portion 110. Here, the direction orthogonal to the axial direction is the same as the gravitational direction. When the safety device 200 moves in the direction orthogonal to the axial direction (in the direction of arrow \textcircled{2}), the interference region A may fill the gap between the knob body NB and the front plate 31. As a result, the knob body NB may not move in the axial direction (in the direction of arrow \textcircled{1}), and the cooking appliance may be in the locked state.

Such a state is shown in FIG. 32. When the safety device 200 moves to the locked position, the interference region A of the safety device 200 may be disposed between the knob body NB and the front plate 31. Accordingly, the knob body NB may not be pressed in the axial direction (in the direction of the arrow in FIG. 7), and the heating device 28 may not be operated.

With reference to FIG. 32, the upper end of the first knob body 120 may interfere with the interference region A. The Reference numeral T indicates an interference point between the upper end of the first knob body 120 and the interference region A. The interference point T may be formed between the through hole 235 and the mounting hole 215.

In FIG. 33 which shows an enlarged view of the interference point T, the end 121b of the first knob body 120 may be in contact with the surface of the interference region A. In this case, the end 121b of the first knob body 120 may be disposed closer to the second body portion 230 than to the first body portion 210 with respect to the stepped portion 237 so as to face the interference region A, which is the surface of the second body portion 230, in the axial direction. The interference point T may be formed on the surface of the second body portion 230. As such, because the interference area is sufficiently secured, the interference state may be maintained more stably.

As shown in FIGS. 34 to 36, the distance in the longitudinal direction between the lower end of the through hole 235 and the center of the mounting hole 215 is indicated as H1. Here, the longitudinal direction refers to a direction based on a virtual extension line connecting the first body portion 210 and the second body portion 230, and is orthogonal to the axial direction. With reference to FIG. 34, the longitudinal direction corresponds to the vertical direction.

In the longitudinal direction, a distance H1 between the lower end of the through hole 235 and the center of the mounting hole 215 may be shorter than a shortest distance H2 between the stepped portion 237 and the center of the mounting hole 215. In the longitudinal direction, the shortest distance H2 between the stepped portion 237 and the center of the mounting hole 215 may be shorter than a distance H3 between the center of the mounting hole 215 and the center of the through hole 235. Reference numeral H4 indicates a distance between the center of the mounting hole 215 and the upper end of the through hole 235.

When the distance H1 between the lower end of the through hole 235 and the center of the mounting hole 215 is shorter than the shortest distance H2 between the stepped portion 237 and the center of the mounting hole 215, the stepped portion 237 may protrude further outward from the end 121b of the knob ring 121 than the lower end of the through hole 235. In this case, interference between the end 121b of the knob ring 121 and the stepped portion 237 in the unlocked position may be more reliably prevented. In addition, in the locked position, the area of the through hole 235 exposed upward may be reduced.

Unlike this, when the safety device 200 moves to the locked position, the stepped portion 237 may be disposed radially inward of the outer end (the end 121b of the knob ring 121) of the knob assembly 100, and the outer end 121b of the knob assembly 100 may interfere with the interference region A, thereby limiting the axial movement of the knob assembly 100 to be in the locked state.

In the present embodiment, the diameter R1 of the mounting hole 215 may be greater than the vertical width of the through hole 235. Since the through hole 235 is not involved in the mounting of the safety device 200 but serves to facilitate the grip of a user, the vertical width of the through hole 235 may not be required to be as large as the diameter R1 of the mounting hole 215. In the present embodiment, the through hole 235 may have an elliptical shape with a longer left-right width than the vertical width. In another example, the through hole 235 may have a circular shape. In this case, the diameter R2 (not shown) of the through hole 235 may be smaller than the diameter R1 of the mounting hole 215.

The through hole 235 may have the closed curve independent of the mounting hole 215. The through hole 235 may not be open in any one direction along the radial direction. When the through hole 235 has the closed curve shape, a user may hold the through hole 235 with a finger and apply strong external force to pull the safety device 200.

In the longitudinal direction, the distance H2 between the stepped portion 237 and the center C1 of the mounting hole 215 may be greater than a distance H3-H2 between the stepped portion 237 and the center C2 of the through hole 235. In this case, when the safety device 200 is mounted on the operation panel 30, the mounting hole 215 may be exposed outside the knob assembly 100. By sufficiently securing the distance H2 between the stepped portion 237 and the center C1 of the mounting hole 215, the through hole 235 and the second end portion 231 of the second body portion 230 may be exposed to a user.

A distance between the second end portion 211 of the first body portion 210, which is spaced farthest from the stepped portion 237, and the center C1 of the mounting hole 215 may be greater than the distance between the stepped portion 237 and the center C1 of the mounting hole 215. When the safety device 200 has such a structure, even if the safety device 200 is applied to base portions 110 of various sizes, the through hole 235 may be exposed outside the knob assembly 100 in the radial direction.

The interference region A may have different axial thicknesses along the longitudinal direction. As shown in FIG. 34, the interference region A may have different thicknesses along the longitudinal direction from the stepped portion 237 to the second end portion 231 of the second body portion 230. More specifically, the interference region A may have a thickness which gradually increases toward a position away from the stepped portion 237. Therefore, an insertion force required when a user inserts the interference region A between the knob body NB and the front plate 31 may be distributed.

Referring to FIG. 35, it is seen that at a position near the lower end of the through hole 235, the thickness of the safety device, that is, a thickness T1 of the first body portion 210, is thinner than the thickness of the safety device at a position near the upper end of the through hole 235, that is, a thickness T1 of the second body portion 230.

The second body portion 230 may include a plurality of regions having different axial thicknesses along the radial direction of the mounting hole 215. With reference to FIG. 34, the second body portion 230 may gradually increase in axial thickness from the lower end thereof to the upper end thereof. In another example, the second body portion 230 may include a plurality of regions in which the axial thickness increases in a stepped manner from the lower end to the upper end.

The interference region A may be defined between the stepped portion 237 and the edge of the second end portion 231 of the second body portion 230. As shown in FIG. 34, in the present embodiment, the interference region A formed on the front surface 230A of the second body portion 230 may be provided between an upper peripheral surface 238 formed on the outer side of the second body portion 230 and the stepped portion 237. Reference numeral 236 indicates peripheral surfaces at opposite side ends of the second body portion 230.

The center C1 of the mounting hole 215 and the center C2 of the through hole 235 may be aligned along the longitudinal direction of the first body portion 210 and the second body portion 230. As shown in FIGS. 34 and 36, the center C1 of the mounting hole 215 and the center C2 of the through hole 235 may be disposed on the same extension line along the longitudinal direction of the safety device 200. In this case, the safety device 200 may have a left-right symmetrical structure with respect to the mounting hole 215 and the through hole 235, so that the safety device 200 may be easily operated by a user from both left and right sides.

The stepped portion 237 may be formed between the first body portion 210 and the second body portion 230. The stepped portion 237 may be formed at the boundary portion between the first body portion 210 and the second body portion 230. When the safety device 200 is disposed in the unlocked position, the stepped portion 237 may be formed to avoid interference thereof with the knob assembly 100. With respect to the stepped portion 237, the axial thickness of the first body portion 210 may be thin, so that the end 121b of the knob ring 121 may face the surface of the first body portion 210, thereby allowing the knob body to be pressed in the axial direction, i.e., the unlocked state. In addition, when the safety device 200 rotates about the base portion 110 in the unlocked state, the stepped portion 237 may allow the safety device 200 to rotate without interfering with the end 121b of the knob ring 121.

The stepped portion 237 may be formed to protrude in the axial direction from the boundary portion. Accordingly, with respect to the stepped portion 237, the axial heights of the surfaces of the first body portion 210 and the second body portion 230 may be formed to be different. With respect to the stepped portion 237, the axial height of the front surface 230A of the second body portion 230 may be higher than the axial height of the front surface 210A of the first body portion 210. Here, protruding in the axial direction may include not only protruding in a direction parallel to the axial direction but also protruding in a direction inclined with respect to the axial direction.

Referring to FIG. 35, the stepped portion 237 may be formed continuously from the outer side of the boundary portion toward the inner side of the boundary portion. A first end portion 237a of the stepped portion 237 formed on the inner side of the stepped portion 237 may face the through hole 235, and a second end portion 237b formed on the outer side of the stepped portion 237 may face the recessed portion. The first end portion 237a and the second end portion 237b may have different axial thicknesses. In the present embodiment, the first end portion 237a may be formed to have a greater axial thickness than the second end portion 237b.

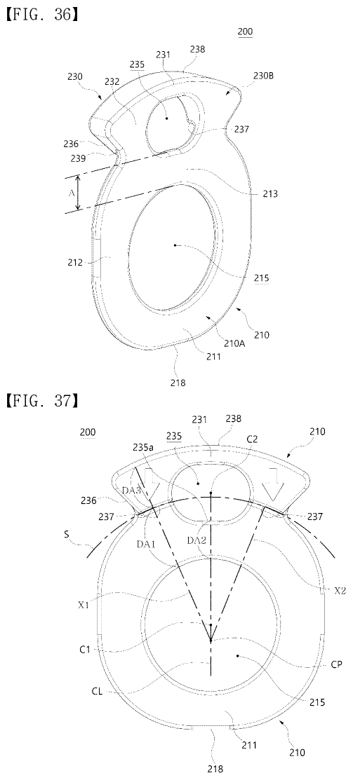

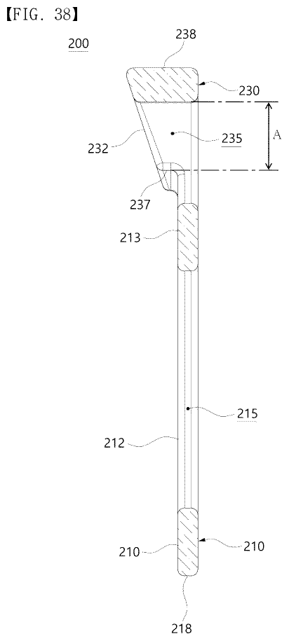

Referring to FIG. 37, in the present embodiment, with respect to the through hole 235, a plurality of stepped portions 237 may be provided on the boundary portion to be spaced apart from each other. The plurality of stepped portions 237 may be arranged along an arc shape. Reference numeral S represents a virtual arc shape passing through the plurality of stepped portions 237.

Virtual extension lines X1 and X2, which extend in normal directions from surfaces of the plurality of step portions 237, respectively, may intersect each other within a region in which the virtual extension lines X1 and X2 overlap with the mounting hole in the axial direction. The virtual extension lines X1 and X2 extending respectively from the surfaces of the plurality of stepped portions 237 in the normal directions may intersect each other below the center of the mounting hole 215, more specifically, at a position closer to the second end portion 211 of the first body portion 210. In this case, the plurality of stepped portions 237 may be arranged along a virtual circle having a diameter larger than that of the mounting hole 215, thereby avoiding interference thereof with the end 121b of the knob ring 121.

In this case, the virtual extension lines X1 and X2 extending in the normal directions from the surfaces of the stepped portions 237 may intersect the virtual centerline CL. In the present embodiment, the two virtual extension lines X1 and X2 extending in the normal directions from the surfaces of the two stepped portions 237 may intersect each other on the centerline CL.

With respect to the longitudinal centerline CL connecting the center of the first body portion 210 and the center of the second body portion 230, the plurality of stepped portions 237 may have a left-right symmetrical structure. When the plurality of stepped portions 237 have a left-right symmetrical structure with respect to the centerline CL, the safety device 200 may avoid interference thereof with the knob assembly 100 in the same manner when rotated in either direction.

Each of the stepped portions 237 may have an inclined surface or a curved surface. The stepped portion 237, which has the inclined or curved surface, may be formed along a path having an arc shape on the boundary portion. Such an inclined or curved surface may have a shape corresponding to the end 121b of the knob ring 121.

With respect to the longitudinal direction, the stepped portions 237 may be formed between the opposite ends of the through hole 235. That is, a virtual line connecting the two stepped portions 237 may cross the through hole 235. This may allow the area and length of the through hole 235 to be sufficiently secured. In another example, the stepped portions 237 may be disposed between the mounting hole and the through hole.

The first end portion of the second body portion may be connected to the stepped portion 237. The second end portion 238 of the second body portion 238 may have a curved shape. When the second end portion of the second body portion 238 has a curved shape, interference thereof with surrounding components of the cooking appliance, such as, another adjacent knob assembly 100, may be prevented during the rotation of the safety device 200.

A shortest distance DA1 between the edge of the mounting hole 215 and the stepped portion 237 may be longer than a shortest distance DA2 between the mounting hole 215 and the through hole 235. Accordingly, both an area between the two holes 215 and 235, which serves as an interference-avoidance region with the knob assembly 100, and the area of the through hole 235, which serves as a handle, may be sufficiently secured.

The shortest distance DA1 between the edge of the mounting hole 215 and the stepped portion 237 may be longer than a shortest distance (DA3) between the stepped portion 237 and the second end portion 238 of the second body portion 230. In this way, while the area between the two holes 215 and 235, which serves as the interference-avoidance region with the knob assembly 100, is sufficiently secured, the protruding distance of the second body portion 230 may be short to prevent interference thereof with another adjacent knob assembly 100.

A recessed portion may be formed between a side surface of the first body portion 210 and a side surface of the second body portion 230. The recessed portion may provide an empty space that a user may grip. The recessed portion may be formed on each of the opposite side surfaces of the safety device 200, respectively.

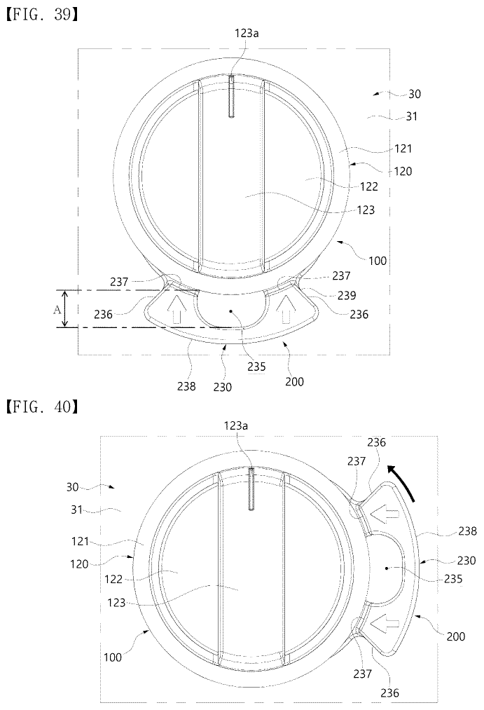

Referring to FIGS. 39 to 42, the process of switching the safety device 200 from the unlocked position to the locked position will be described. First, FIG. 39 shows the safety device 200 disposed at the unlocked position. In the unlocked position, the first body portion 210 of the safety device 200 may face downward, and the second body portion 230 thereof may face upward. When a user does not operate the safety device 200, the second body portion 230 may face downward due to gravity. This position of the safety device 200 may be referred to as the first position.

In this case, due to the thickness of the second body portion 230, the relatively heavy second body portion 230 may face downward due to gravity with the mounting hole 215 as a rotation center, and thus may be in the unlocked state. In this way, the safety device 200 of the present embodiment may basically have the unlocked position, and the safety device 200 may be rotated to the locked position only when a user requires.

As shown in FIG. 39, a portion or the entirety of the interference region A may be exposed downward from the knob assembly 100. Therefore, a user may recognize that the safety device 200 has not yet limited the pressing of the knob assembly 100. The entirety of the through hole 235 may be exposed downward from the knob assembly 100, allowing a user to easily grip the through hole 235.

In addition, with respect to the stepped portions 237, the entire second body portion 230 may be disposed radially outward more than the knob ring 121. That is, in the unlocked state in which the second body portion 230 protrudes maximally from the knob assembly 100 in the radial direction, the stepped portions 237 may be disposed radially outward more than the outer circumferential surface of the knob assembly 100. Accordingly, the knob ring 121 is disposed inward more than the second body portion 230, preventing interference.

In the present embodiment, in the unlocked state in which the second body portion 230 protrudes maximally from the knob assembly 100 in the radial direction, a radial distance between the center of the drive shaft 71 (i.e., the center of the knob assembly 100 in view of FIG. 39) and the radial end of the knob assembly (i.e., the end of the knob ring 121) may be shorter than a radial distance between the center of the drive shaft 71 (i.e., the center of the knob assembly 100 in view of FIG. 39) and the stepped portions 237. As a result, the stepped portions 237 may be disposed outward more than the end of the knob ring 121.

FIG. 40 shows a state in which the safety device 200 is rotated 90 degrees counterclockwise. A user may grip the through hole 235 and rotate the safety device 200. In this case, the mounting hole 215 may serve as the rotational center. Even in the state of FIG. 40, when the user moves the safety device 200 toward the drive shaft 71 (to the left on the basis of the drawing), the interference region A may be press-fitted between the knob body NB and the front plate 31. However, in this case, the interference may not be strongly pressed, or the safety device 200 may be restored to the state of FIG. 39 by gravity over time.

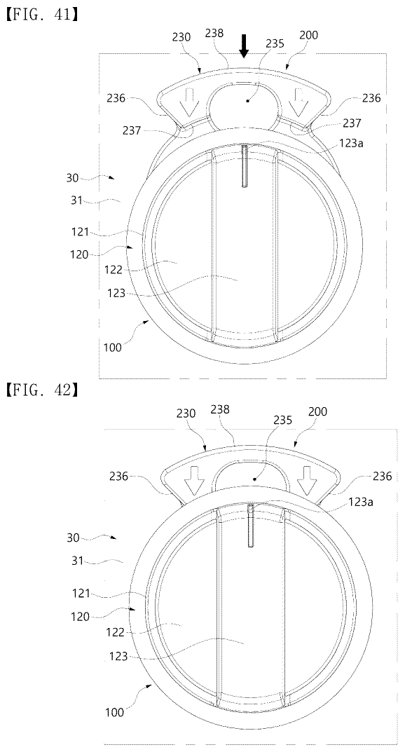

FIG. 41 shows a state where the safety device 200 is further rotated counterclockwise by 90 degrees from the state shown in FIG. 40. In this case, the second body portion 230 faces the 12 o'clock position. In this state, the safety device 200 may move in the vertical direction. This movement is possible because the inner diameter R1 of the mounting hole 215 is larger than the outer diameter R3 of the base portion 110. The position of the safety device 200 in the state shown in FIG. 41 may be referred to as the second position.

In the present embodiment, when the safety device 200 moves from the first position to the second position, the safety device 200 may not interfere with the end of the knob ring 121 due to the stepped portions 237. This is because the stepped portions 237 protrude radially outward more than the end of the knob ring 121. At the same time, interference of the safety device 200 with another adjacent knob assembly 100 may also be prevented during the rotation of the safety device 200 from the first position to the second position. This is because, with the stepped portions 237 as a center, the second end portion 238 of the second body portion 230 is formed in an arcuate shape, and the radial length of the second body portion 230 is formed short.

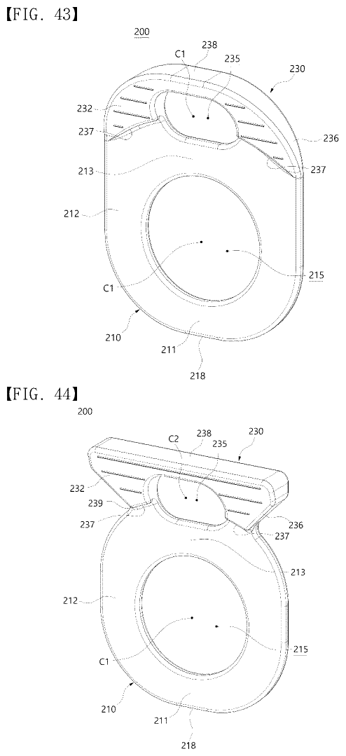

Meanwhile, when a user presses the safety device 200 in the direction of the arrow in FIG. 41, the safety device 200 may be switched to the state shown in FIG. 42. That is, the interference region A of the safety device 200 may be inserted between the knob body NB and the front plate 31 and may be in the locked state. Referring to FIG. 42, most of the interference region A may be hidden by the knob body NB. Therefore, a user may see this state and realize that the cooking appliance is in the locked state. This position of the safety device 200 may be referred to as the third position of the safety device 200.

In this way, the safety device 200 may be disposed at the upper end (12 o'clock position) of the knob assembly 100. The safety device 200 disposed at the upper end of the knob assembly 100 may be supported by the knob assembly 100, so there is no risk of downward movement of the safety device 200 due to gravity. Accordingly, the rotation of the safety device 200 due to gravity, which may unintentionally release the locked state of the cooking appliance, may be prevented.

In the third position, the stepped portions 237 of the safety device 200 may be concealed by the knob assembly 100. That is, the stepped portions 237 may move radially closer to the drive shaft 71 than the end of the knob ring 121, thereby being hidden behind the knob ring 121.

FIG. 43 illustrates the configuration of a safety device 200 for a cooking appliance according to an eleventh embodiment of the present disclosure. Descriptions of structures identical to those of the previous embodiments are omitted, and only differing structures will be described. In the present embodiment, the recessed portion may be omitted from the safety device 200. A first body portion 210 and a second body portion 230, which constitute the safety device 200, may be connected to each other to form a substantially elliptical shape. A user may utilize a through hole 235, which is formed between the first body portion 210 and the second body portion 230, as a handle.

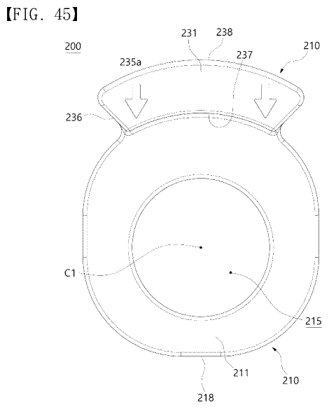

FIG. 44 illustrates the configuration of a safety device 200 for a cooking appliance according to a twelfth embodiment of the present disclosure. Descriptions of structures identical to those of the previous embodiments are omitted, and only differing structures will be described. In the present embodiment, the upper peripheral surface 238 of the second body portion 230 may have a planar structure. The planar upper peripheral surface 238 may allow the recessed portion between the first body portion 210 and the second body portion 230 to have an increased depth.

FIG. 45 illustrates the configuration of a safety device 200 for a cooking appliance according to a thirteenth embodiment of the present disclosure. Descriptions of structures identical to those of the previous embodiments are omitted, and only differing structures will be described. In the present embodiment, the through hole may be omitted in the safety device 200. A stepped portion 237 may be formed in the safety device 200 so as to be spaced apart from the mounting hole 215. The stepped portion 237 may be formed along a continuous arc shape.

The foregoing description is merely illustrative of the technical idea of the present disclosure, and it will be understood by those skilled in the art that various modifications and variations may be made without departing from the essential characteristics of the present disclosure. Accordingly, the embodiments disclosed herein are not intended to limit the technical idea of the present disclosure, but rather to explain it, and the scope of the technical idea of the present disclosure is not limited by such embodiments. The scope of protection of the present disclosure shall be interpreted on the basis of the following claims, and all technical ideas falling within the equivalent scope thereof shall be construed as being included within the scope of rights of the present disclosure.

What is claimed is:

1. A safety device for a cooking appliance configured to limit an operation of a knob assembly moved rectilinearly in an axial direction of a drive shaft, the safety device comprising:
a first body portion; and
a second body portion having a first end portion connected to the first body portion and a second end portion spaced apart from the first end portion in a longitudinal direction thereof,
wherein the first body portion has a mounting hole through which the drive shaft passes and which serves as a rotational center of the safety device, and
the second body portion has an interference region defined therein, with the interference region having a thickness in the axial direction greater than a thickness of the first body portion in the axial direction.

2. The safety device of claim 1, wherein the mounting hole is formed at a position outside the interference region.

3. The safety device of claim 1, wherein the interference region has different axial thicknesses along the longitudinal direction.

4. The safety device of claim 1, wherein an inner diameter of the mounting hole is larger than an outer diameter of the drive shaft or an outer diameter of a base portion through which the drive shaft passes.

5. The safety device of claim 1, wherein a partition portion is defined between the first body portion and the first end portion of the second body portion connected to the first body portion,
with respect to the partition portion, the axial thickness of the second body portion is greater than the axial thickness of the first body portion, and
the mounting hole is formed at a position spaced from the partition portion toward a second end portion of the first body portion.

6. The safety device of claim 5, wherein the interference region is defined between the partition portion and the second end portion of the second body portion.

7. The safety device of claim 1, wherein the mounting hole forms a closed curve within the first body portion.

8. The safety device of claim 1, wherein the first body portion has a uniform axial thickness throughout an entire region thereof and continuously surrounds an edge of the mounting hole along a circumferential direction of the mounting hole.

9. The safety device of claim 1, wherein the first body portion and the second body portion are partitioned with respect to a partition portion and have thicknesses different from each other with respect to the partition portion.

10. The safety device of claim 1, wherein the first body portion and the second body portion are partitioned with respect to a partition portion,
a first end portion of the first body portion and the first end portion of the second body portion are connected to the partition portion, and
a distance between a second end portion of the first body portion, which is spaced farthest from the partition portion, and the partition portion is greater than a distance between the second end portion of the second body portion, which is spaced farthest from the partition portion, and the partition portion.

11. The safety device of claim 1, wherein the first body portion and the second body portion are partitioned with respect to a partition portion,
a first end portion of the first body portion and the first end portion of the second body portion are connected to the partition portion, and
a distance between a second end portion of the first body portion, which is spaced farthest from the partition portion, and a center of the mounting hole is greater than a distance between the partition portion and the center of the mounting hole.

12. The safety device of claim 1, wherein the second body portion comprises a through hole having a closed curve independent of the mounting hole.

13. The safety device of claim 12, wherein a diameter of the mounting hole is greater than a diameter of the through hole.

14. The safety device of claim 1, wherein the first body portion and the second body portion are partitioned with respect to a partition portion,
the second body portion comprises a through hole having a closed curve independent of the mounting hole, and
a distance between the partition portion and a center of the mounting hole is greater than a distance between the partition portion and a center of the through hole.

15. The safety device of claim 1, wherein stepped portions having thicknesses changing in the axial direction are formed on a boundary portion between the first body portion and the second body portion.

16. The safety device of claim 15, wherein the stepped portions are formed to protrude in the axial direction from the boundary portion.

17. The safety device of claim 15, wherein on the boundary portion, the plurality of stepped portions is provided to be spaced apart from each other,
wherein the plurality of stepped portions is arranged along an arcuate shape.

18. The safety device of claim 15, wherein on the boundary portion, the plurality of stepped portions is provided, and
virtual extension lines, which extend in normal directions from surfaces of the plurality of stepped portions, respectively, intersect each other within a region in which the virtual extension lines overlap with the mounting hole in the axial direction.

19. The safety device of claim 15, wherein on the boundary portion, the plurality of stepped portions is provided,
wherein with respect to a longitudinal centerline connecting a center of the first body portion and a center of the second body portion, the plurality of stepped portions has a left-right symmetrical structure.

20. A cooking appliance comprising:
a drive shaft protruding forward through an operation panel;
a knob assembly coupled to the drive shaft and configured to rectilinearly move in an axial direction of the drive shaft; and
a safety device disposed between the operation panel and the knob assembly,
wherein the safety device comprises:
a first body portion having a mounting hole through which the drive shaft passes, and
a second body portion having a first end portion connected to the first body portion and a second end portion spaced apart from the first end portion along a direction different from the axial direction,
wherein the mounting hole through which the drive shaft passes and which serves as a rotational center of the safety device is formed in the first body portion,
wherein an interference region having a thickness in the axial direction greater than a thickness of the first body portion in the axial direction is defined in the second body portion so that movement of the knob assembly in the axial direction is limited.
